(19) United States
(12) Patent Application Publication
(10) Pub. No.: US 2005/0027117 A1
(43) Pub. Date: Feb. 3, 2005

(54) Anticoagulant and antithrombotic LMW-glycosaminoglycans derived from K5 polysaccharide and process for their preparation

(76) Inventors: Pasqua Oreste, Milano (IT); Giorgio Zoppetti, Milano (IT)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/868,359

(22) Filed: Jun. 16, 2004

Related U.S. Application Data
(63) Continuation-in-part of application No. 09/950,003, filed on Sep. 12, 2001.
Application No. 09/950,003 is a continuation-in-part of application No. 09/738,879, filed on Dec. 18, 2000, now abandoned.

(30) Foreign Application Priority Data
Dec. 17, 2003 (IT) MI2003A002498

(51) Int. Cl. C08B 37/00

(52) U.S. Cl. 536/54

(57) ABSTRACT

Low molecular weight glycosaminoglycans derived from K5 polysaccharide having an activity of the same order of magnitude as that of low molecular weight heparin on the coagulation parameters and a lower hemorrhagic risk are obtained starting from an optionally purified K5 polysaccharide by a process comprising the sequential steps of N-deacetylation/N-sulfation, C5-epimerization, depolymerization of the obtained epiK5-N-sulfate, O-oversulfation of the LMW-epiK5-N-sulfate, selective O-desulfation, 6-O-sulfation, N-sulfation.

### CROSS REFERENCE TO RELATED APPLICATION

This application is a continuation-in-part of application Ser. No. 09/950,003, filed on Sep. 12, 2001, which is a continuation-in-part of application Ser. No. 09/738,879 filed on Dec. 18, 2000, abandoned.

### OBJECT OF THE INVENTION

The present invention concerns novel low molecular weight (LMW) glycosaminoglycans having an activity on the coagulation parameters of the same order as that of low molecular weight heparin (LMWH). These LMW glycosaminoglycans are obtainable from polysaccharide K5 by a reaction sequence consisting of a N-deacetylation, a N-sulfation, a partial C5-epimerization, a depolymerization, an O-oversulfation, a selective O-desulfation, a 6-O-resulfation and a final N-sulfation.

### BACKGROUND OF THE INVENTION

Glycosaminoglycans, such as heparin, heparan sulfate, dermatan sulfate, chondroitin sulfate and hyaluronic acid, are biopolymers industrially extracted from different animal organs.

In particular heparin, principally obtained by extraction from intestinal pig mucosa or bovine lung, is a mixture of chains consisting of repeating disaccharide units formed by an uronic acid (L-iduronic acid or D-glucuronic acid) and by an amino sugar (glucosamine), joined by α-1→4 or β-1→4 bonds. The uronic acid unit may be sulfated in position 2 and the glucosamine unit is N-acetylated or N-sulfated and 6-O sulfated. Moreover, glucosamine can contain a sulfate group in position 3 in an amount of about 0.5%. Heparin is a polydisperse copolymer with a molecular weight ranging from about 3,000 to about 30,000 D.

Besides the main anticoagulant and antithrombotic activities, heparin also exerts antilipemic, antiproliferative, antiviral, anticancer and antimetastatic activities. To satisfy the major request of starting material for these new therapeutic areas a new alternative route of production different from the extractive ones from animal tissues is necessary.

The natural biosynthesis of heparin in mammalians and the properties of this product have been described by Lindahl et al. 1986 in Lane D. and Lindahl U. (Eds.) “Heparin-Chemical and Biological Properties; Clinical Applications”, Edward Arnold, London, pages159-190 and Lindahl U., Feingold, D. S. and Rodén L. (1986) TIBS, 11, 221-225.

The sequence formed by the pentasaccharide region of linkage for Antithrombin III (ATIII) named active pentasaccharide that is the structure needed for the high affinity binding of heparin to ATIII, is fundamental for heparin activity. This sequence contains one glucosamine unit sulfated in position 3, that is not normally present in the other parts of the heparin chain. Beside the activity through ATIII, heparin exerts its anticoagulant and antithrombotic activity through the activation of heparin cofactor II (HCII) and a selective inhibition of thrombin. It is known that the minimum saccharidic sequence necessary for HCII activation is a chain containing at least 24 monosaccharides (Tollefsen D. M., 1990 Seminars in Thrombosis and Haemostasis 16, 66-70).

Description of the Prior Art

It is known that the capsular polysaccharide K5 isolated from the strain of Escherichia Coli, described by Vann W. F., Schmidt M. A., Jann B., Jann K., (1981) in European Journal of Biochemistry 116, 359-364, shows the same sequence of heparin and heparan sulfate precursor (N-acetylheparosan), namely a mixture of chains constituted by repeating disaccharide glucoronyl-β-1→4-glucosamine structures (A). This compound was chemically modified as described by Lormeau et al. in the U.S. Pat. No. 5,550,116 and by Casu et al. in Carbohydrate Research, 1994, 263, 271-284 or chemically and enzymatically modified in order to obtain products showing in vitro biological activities in coagulation of the same type of heparin as extracted from animal organs.

The chemical and enzymatic modification of polysaccharide K5 was described for the first time in IT 1230785, wherein the polysaccharide K5 (hereinbelow also simply referred to as “K5”) is submitted to (a) a N-deacetylation and a N-sulfation; (b) an enzymatic C5-epimerization of the glucuronic units; (c) a 2-0 and/or 6-O-sulfation; and (d) an optional enzymatic 3-O-sulfation, but this method does not give products having a satisfactory activity in respect of that of heparin as extracted from animal organs, hereinafter referred to as “commercial heparin” or “standard heparin”, the latter expression designating the fourth International Standard of heparin.

WO 92/17507 discloses a method for preparing heparin-like products starting from K5 by (a) N-deacetylation and N-sulfation, (b) C5 epimerization, and (c) O-sulfation, step (c) being optionally followed by a N-resulfation. According to this method, the amount of iduronic acid of the resulting product is low (about 20% of the global content of uronic acids).

WO 96/14425 and U.S. Pat. No. 5,958,899 disclose an improved method for the preparation of heparin-like products having a high iduronic acid content, starting from K5, by (a) N-deacetylation and N-sulfation, (b) epimerization by a C5 epimerase, and (c) sulfation of at least some free hydroxy groups, step (b) being conducted under controlled conditions. The products obtained according to this method lack a considerable amount of N-sulfate groups, lost during the O-sulfation.

WO 97/43317 and U.S. Pat. No. 6,162,797 disclose derivatives of K5 having high anticoagulant activity which are prepared by submitting K5 to (a) N-deacetylation and N-sulfation, (b) C5-epimerization, (c) O-oversulfation of the epimerized product, previously transformed in a salt thereof with an organic base, and dialysis, and (d) N-resulfation. The products obtained according to this method exhibit a very high global anticoagulant activity.

WO 98/42754 discloses a method for the preparation of glycosaminoglycans, including derivatives of K5, having high antithrombotic activity, said method, in the case of K5, consisting of (a) N-deacetylation and N-sulfation, (b) epimerization by C5 epimerase, (c) O-oversulfation, (d) partial solvolytic O-desulfation of a salt of the oversulfated product, (e) N-resulfation, and, optionally, (f) O-resulfation. The products obtained according to this method have the disadvantage of lacking either O-sulfate groups when the optional O-resulfation step (f) is not performed, or N-sulfate groups, which are lost when step (f) is performed. Thus, the incomplete N— or O—, expecially 6-O-sulfation (always below 60%) involves, in the case of C5-epimerized K5 polysaccharide, very low anti-Xa values, thus giving a very low anti-Xa/aPPT ratio.

The attainment of the products having an activity on coagulation of the same type as that of extractive heparin occurs by processes which mimic that occurring in nature and comprise the key step of C5-epimerization with D-glucuronyl C5 epimerase.

The D-glucuronyl C5-epimerase from bovine liver was purified by Campbell, P. et al. in J. Biol. Chem., 1994, 269/43, 26953-26958 (“Campbell 1994”) who also supplied its composition in amino acids and described its use in solution for the transformation of a K5-N-sulfate into the corresponding 30% epimerized product, demonstrating the formation of iduronic acid by HPLC method following a total nitrous depolymerization up to disaccharide.

The document WO 98/48006 describes the DNA sequence which codes for the D-glucuronyl C5-epimerase and a recombinant D-glucuronyl C-5 epimerase, obtained from a recombinant expression vector containing said DNA, subsequently purified by Campbell et al. as shown by Jin-Ping L. et al. in J. Biol. Chem. 2001, 276, 20069-20077 (“Jin-Ping 2001”).

The complete C5-epimerase sequence was described by Crawford B. E. et al. in J. Biol. Chem., 2001, 276(24), 21538-21543 (Crawford 2001).

In the patent application PCT/IB03/02338 (WO 03/106504), incorporated herein by reference, there are disclosed epiK5-amine-O-oversulfate-derivatives useful as intermediates in the preparation of epiK5-N,O-oversulfate-derivatives having antiangiogenetic and antiviral activity. Said epiK5-amine-O-oversulfate-derivatives are prepared by a process which comprises treating an epiK5-N-sulfate-derivative with, preferably, tetrabutylammonium hydroxide, by letting the reaction mixture to stand for a period of time of 30-60 minutes at a pH of about 7 and isolating the salt, preferably the tetrabutylammonium salt, thus obtained; and treating said salt with an O-sulfating agent under O-oversulfation conditions. The above mentioned document discloses the preparation of LMW-epiK5-amine-O-oversulfates starting from a LMW-epiK5-N-sulfate.

The same document WO 03/106504, as well as the documents IT M12002A001346 and IT M12002A001854, also incorporated herein by reference, disclose for the first time LMW-epiK5-N-sulfates, preferably free of N-acetyl and amino groups, wherein the content in iduronic acid in respect of the total of uronic acids is of 40%-60%, preferably around 50%. Said LMW-epiK5-N-sulfates are useful intermediates in the preparation of LMW-epiK5-N,O-sulfates having a high degree of activity on various biological parameters, in particular on coagulation parameters (IT MI2002A001346). The preparation of said LMW-epiK5-N-sulfates is described in detail in the three above documents.

In order to uniform the terminology and render the text more comprehensible, in the present description conventional terms or expressions will be used, in the singular or plural. In particular:
by “K5” or “K5 polysaccharide” is meant the capsular polysaccharide from Escherichia coli obtained by fermentation, i.e. a mixture of chains consisting of disaccharide units (A) optionally containing a double bond at the non-reducing end as illustrated above, howsoever prepared and purified according to the methods described in literature, in particular according to Vann 1981, according to Manzoni M. et al., Journal of Bioactive Compatible Polymers, 1996, 11, 301-311 (“Manzoni 1996”) or according to the method described hereinbelow; it is obvious for a person skilled in the art that what is shown hereafter can be applied to any N-acetylheparosan;
by “C5-epimerase” is meant the D-glucuronyl C-5 epimerase, extractive or recombinant, howsoever prepared, isolated and purified, in particular as described in Campbell 1994, in WO 98/48006, in Jin-Ping L. et al. in J. Biol. Chem. 2001, 276, 20069-20077 (Jin-Ping 2001”) or in Crawford 2001;
by K5-amine is meant at least 95% N-deacetylated K5, preferably a K5 fully N-deacetylated, namely in which N-acetyl groups are undetectable with a normal NMR apparatus;
by “K5-N-sulfate” is meant at least 95%, preferably 100%, N-deacetylated and N-sulfated K5, preferably a K5 fully N-deacetylated and N-sulfated, namely in which N-acetyl and NH₂ groups are undetectable with a normal NMR apparatus;
by “epiK5” is meant the K5 and its derivatives in which 40%-60% of the glucuronic units is C5-epimerized to iduronic units
by “epiK5-N-sulfate” is meant K5-N-sulfate in which 40%-60% of the glucuronic units is C5-epimerized to iduronic units;
by “epiK5-amine-O-oversulfate” is meant an epiK5-amine-O-sulfate with a sulfation degree of at least 2;
by “epiK5-N,O-sulfate” is meant a K5-N,O-sulfate wherein 40%-60% of the glucuronic units is C5-epimerized to iduronic units, with a sulfation degree of from 2.3 to 2.9;
the hereinabove defined conventional terms and expressions refer to K5 as isolated after fermentation, generally with a molecular weight distribution from approximately 1,500 to approximately 50,000 with a mean molecular weight of 12,000-35,000, advantageously of 15,000-25,000;
unless the molecular weight is otherwise specified, the conventional terms and expressions defined hereinabove, when preceded by the acronym “LMW” (low molecular weight), in particular LMW-epiK5-N-sulfate, LMW-epiK5-amine-O-oversulfate, LMW-epiK5-N,O-sulfate, designate low molecular weight products having a mean molecular weight of from about 1,500 to about 12,000;
when followed by “-derivative”, the conventional terms and expressions as defined hereinabove, indicate both the derivatives from native K5 and those of low molecular weight K5, as a whole;
the term “depolymerized-LMW-epiK5-N-sulfate”, designates a LMW-epiK5-N-sulfate obtained by chemical depolymerization of epiK5-N-sulfate as illustrated hereinbelow; analogously, the terms “depolymerized-LMW-epiK5-amine-O-oversulfate” and “depolymerized-LMW-epiK5-N,O-sulfate” designate a LMW-epiK5-amine-O-oversulfate and, respectively, a LMW-epiK5-N,O-sulfate obtained starting from a depolymerized-LMW-epiK5-N-sulfate.
   Furthermore:
unless otherwise specifically indicated, the term “molecular weight” or “mean molecular weight” indicates the molecular weight determined by HPLC against standard of heparin and low molecular weight heparin;
by the term “approximately” or “about”, referring to the molecular weight, is meant the molecular weight measured by viscosimetry±the theoretical weight of a disaccharide unit, including the weight of the sodium, calculated as 461 in the case of an epiK5-N-sulfate-derivative and 644 in the case of a epiK5-N,O-sulfate-derivative with a sulfation degree of 2.8;
by the expression “preponderant species”, is meant the compound which, in the mixture constituting the LMW-epiK5-N-sulfate, the LMW-epiK5-amine-O-oversulfate or the LMW-epiK5-N,O-sulfate, is the most represented species, determined by the peak of the curve of the molecular weight measured by HPLC;
unless otherwise specifically stated, by “degree of sulfation” is meant the SO₃⁻/COO⁻ ratio, expressible also as the number of sulfate groups per disaccharide unit, measured by the conductimetric method described by Casu B. et al. in Carbohydrate Research, 1975, 39, 168-176 (Casu 1975);
by “O-oversulfation conditions” is meant an extreme O-sulfation performed, for example, according to the Method C described by B. Casu et al. in Carbohydrate Research, 1994, 263, 271-284 (Casu 1994);
by the term “alkyl” is meant a linear or branched alkyl, whereas “tetrabutylammonium” denotes the tetra(n-butyl)ammonium group.
   Finally, it is to be noted that, in the literature, the polysaccharide K5 (K5) is also called “N-acetylheparosan”. Thus, K5-amine corresponds to “aminoheparosan”, K5-N-sulfate corresponds to “sulfaminoheparosan”, and so on, while, when these products are epimerized, in the literature the above terms are preceded by the term “epimerized”. In this context, the present description refers to “K5” in order to emphasize the origin of the products disclosed herein.

Unless otherwise specified, starting K5 and its derivatives are intended in form of their sodium salts.

### SUMMARY OF THE INVENTION

We have found new glycosaminoglycans derived from K5 polysaccharide from Escherichia coli with a molecular weight from 3,000 to 30,000, containing from 25% to 50% by weight of the chains with high affinity for ATIII and with a high anticoagulant and antithrombotic activity which is comprised between 1.5 and 4 if the results are expressed as ratio HCII/Anti-Xa activities with a prevalence of the activities which implies thrombin inhibition.

Said glycosaminoglycans are synthesized through a process comprising some steps of chemical and enzymatic modification and characterized by a step of epimerization from D-glucuronic acid to L-iduronic acid using the enzyme glucuronosyl C5 epimerase in solution or in immobilized form in presence of specific divalent cations, said enzyme being chosen from the group including recombinant glucuronosyl C5 epimerase, glucuronosyl C5 epimerase from murine mastocytoma and glucuronosyl C5 epimerase extracted from bovine liver and said divalent cations being chosen from the group comprising Ba, Ca, Mg and Mn.

More particularly, the process for the preparation of said glycosaminoglycans substantially comprises the following steps: (i) N-deacetylation/N-sulfation of the polysaccharide K5, (ii) partial C-5 epimerization of the carboxyl group of the glucuronic acid moiety to the corresponding iduronic acid moiety, (iii) oversulfation, (iv) selective O-desulfation, (v) optional selective 6-O-sulfation, and (vi) N-sulfation. We have also found that different compounds are obtained by modulating the reaction time of the selective O-desulfation.

Moreover, we have found that, by carrying out the O-desulfation of the product obtained at the end of step (iii), whenever prepared according to the steps (i)-(iii), for a period of time of from 135 to 165 minutes, new compounds are obtained which show the best antithrombotic activity and a bleeding potential lower than that of any other heparin-like glycosaminoglycan.

It has particularly been found that new glycosaminoglycans having a very high antithrombin activity and a bleeding potential lower than that of heparin may be obtained by a process which sequentially comprises (i) N-deacetylation/N-sulfation of the polysaccharide K5, (ii) partial C-5 epimerization of the carboxyl group of the glucuronic acid moiety to the corresponding iduronic acid moiety, (iii) oversulfation, (iv) time and temperature controlled selective O-desulfation, (v) 6-O-sulfation, (vi) N-sulfation, and also comprises an optional depolymerization step at the end of one of steps (ii)-(vi). Due to this reactions' sequence, these novel glycosaminoglycans are almost completely N-sulfated and highly 6-O-sulfated, thus being different from those obtained by the previously described methods.

More particularly, it has surprisingly been found that, if in step (iv) of the above process the selective O-desulfation of the product obtained at the end of step (iii) is carried out in a mixture dimethyl sulfoxide (DMSO)/methanol for a period of time of from 135 to 165 minutes at a temperature of 50-70° C., new glycosaminoglycans of heparin-type are obtained, said glycosaminoglycans having an anti-Xa activity at least of the same order of standard heparin and a global anticoagulant activity, expressed for example as aPTT, lower than that of standard heparin, a Heparin Cofactor II (HCII) activity at least as high as that of standard heparin and an anti-IIa (antithrombin) activity much higher than that of standard heparin, said novel glycosaminoglycans also having a reduced bleeding risk in respect of commercial heparin. Furthermore, it has been found that by carrying out step (iv) under the above-illustrated conditions, the biological activity with low bleeding risk of the compound obtained at the end of step (vi) is maintained after depolymerization, said activity of the depolymerized product being expressed by a very high antithrombin activity, anti-Xa and HCII activities of the same order as that of standard heparin and a global anticoagulant activity lower than that of standard heparin. Thus, by carrying out step (iv) under these controlled conditions, it is possible to overcome the above-mentioned disadvantages of the known processes and to obtain new glycosaminoglycans, having improved and selective antithrombin activity, useful as specific coagulation-controlling and antithrombotic agents.

More surprisingly, it has also been found that, if in the process for the preparation of glycosaminoglycans derived from K5 comprising the following steps: (i) N-deacetylation/N-sulfation of the polysaccharide K5, (ii) partial C-5 epimerization of the carboxyl group of the glucuronic acid moiety to the corresponding iduronic acid moiety, (iii) oversulfation, (iv) selective O-desulfation, (v) selective 6-O-sulfation, and (vi) N-sulfation, the epiK5-N-sulfate obtained at the end of step (ii) is submitted to a deolymerization step (ii′) before steps (iii)-(vi), new depolymerized-LMW-epiK5-N,O-sulfates having unexpected properties are obtained at the end of step (vi). In particular, it has unexpectedly been found that, under these conditions it is possible to obtain depolymerized-LMW-epiK5-N,O-sulfates having an activity of the same order of magnitude as that of low molecular heparin on the coagulation parameters coupled with a much lower hemorrhagic risk.

Morerover, it has been found that, by introducing a depolymerization step after the C5-epimerization step (ii), in the subsequent step (iv) it is no longer necessary to operate under the above mentioned, fixed time and temperature conditions, and the selective partial O-desulfation with dimethyl sulfoxide/methanol may be carried out in a more large range of temperature and time to obtain depolymerized-LMW-epiK5-N,O-sulfates having a sulfation degree of from 2.3 to 2.9, active on the coagulation parameters.

### BRIEF DESCRIPTION OF THE DRAWINGS

FIG. 1 shows the ¹H-NMR spectrum of the K5 polysaccharide working standard obtained according to Vann W. F. et al. 1981 European Journal of Biochemistry 116, 359-364, repeating the purification till the almost complete disappearance of the peaks in the region of 4.9 to 5.2 ppm of the ¹H-NMR spectrum.

FIG. 2 shows the ¹H-NMR spectrum of the starting K5 polysaccharide of example 1 (a) and example 12.

FIG. 3 shows the ¹H-NMR spectrum of the purified K5 polysaccharide obtained in example 1 (a) and in example 12.

FIG. 4 shows the ¹³C-NMR spectrum of the N-sulphate K5 polysaccharide obtained in example 1 (b) and example 12 (i).

FIG. 5 shows the ¹H-NMR spectrum of the efficiency of the immobilized C-5 epimerase in example 1 (c-1) and example 12 (ii-1).

FIG. 6 shows the ¹H-NMR spectrum of the epimerized product obtained in example 1 (c-2).

FIG. 7 shows the ¹³C-NMR spectrum of the oversulfate compound obtained in example 1 (d).

FIG. 8 shows the ¹³C-NMR spectrum of the desulfated compound obtained in example 1 (e).

FIG. 9 shows the ¹³C-NMR spectrum of the compound obtained in example 1 (g).

FIG. 10 shows the chromatographic profile of the compound obtained in example 3.

FIG. 11A shows the chromatographic profile of the compound at high molecular weight obtained in example 10.

FIG. 11B shows the chromatographic profile of the compound at low molecular weight obtained in example 10.

FIG. 12 shows the ¹H-NMR spectrum of the epimerized product obtained in example 12 (ii)

FIG. 13 shows the ¹³C-NMR spectrum of the oversulfated compound obtained in example 12 (iii).

FIG. 14 shows the ¹³C-NMR spectrum of the desulfated compound obtained in example 12 (iv).

FIG. 15 shows the ¹³C-NMR spectrum of the compound obtained in example 12 (vi).

FIG. 16 shows the ¹³C-NMR spectrum of the low molecular weight compound obtained in example 13

FIG. 17 shows the ¹³C-NMR spectrum of the depolymerized-LMW-epiK5-amine-O-sulfate of Example 18 (iv′).

FIG. 18 shows the ¹³C-NMR spectrum of the depolymerized-LMW-epiK5-amine-O-sulfate containing at least 80% of 6-O-sulfate of Example 18 (v′).

FIG. 19 shows the ¹³C-NMR spectrum of the final depolymerized-LMW-epiK5-amine-N,O-sulfate of Example 18 (vi′), which, in contrast with that given in FIG. 16, indicates the presence of sulfated 2,5-anhydromannitol units.

### DETAILED DESCRIPTION OF THE INVENTION

The present invention relates to glycosaminoglycans derived from K5 polysaccharide from Escherichia Coli (further simply named K5), obtained by a process which includes the following steps:
(a) Preparation of K5 from Escherichia Coli
(b) N-deacetylation/N-sulfation
(c) C5 epimerization
(d) Oversulfation
(e) Selective O-desulfation
(f) Selective 6-0 sulfation (optional)
(g) N-sulfation
   The different steps of the process are detailed as follows.
(a) Preparation of K5 from Escherichia Coli

First a fermentation in flask is performed according to the patent M199A001465 (WO 01/02597) and using the following medium:

| | | |
|---|---|---|
| Defatted soy | 2 | g/l |
| K₂HPO₄ | 9.7 | g/l |
| KH₂PO₄ | 2 | g/l |
| MgCl₂ | 0.11 | g/l |
| Sodium citrate | 1 | g/l |
| Ammonium sulfate | 1 | g/l |
| Glucose | 2 | g/l |
| Water | 1,000 | ml |
| pH 7.3 | | |

The medium is sterilized at 120° C. for 20 minutes. Glucose is prepared separately as a solution that is sterilized at 120° C. for 30 minutes and sterile added to the medium. The flask is inoculated with a suspension of E. Coli cells Bi 8337/41 (O10:K5:H4) from a slant containing tryptic soy agar and incubated at 37° C. for 24 hours under controlled stirring (160 rpm, 6 cm of run). The bacterial growth is measured counting the cells with a microscope. In a further step, a Chemap-Braun fermentor with a volume of 14 liters containing the same medium above is inoculated with the 0.1% of the above flask culture and the fermentation is performed with 1 vvm aeration (vvm=air volume for liquid volume for minute), 400 rpm stirring and temperature of 37° C. for 18 hours. During the fermentation pH, oxygen, residual glucose, produced K5 polysaccharide and bacterial growth are measured.

At the end of the fermentation the temperature is raised to 80° C. for 10 minutes. The cells are separated from the medium by centrifugation at 10,000 rpm and the supernatant is ultrafiltrated through a SS316 (MST) module equipped with PES membranes with a nominal cut off of 800 and 10,000 D to reduce the volume to ⅕. Then K5 polysaccharide is precipitated adding 4 volumes of acetone at 4° C. and left to sediment for one night at 4° C. and finally is centrifuged at 10,000 rpm for 20 minutes or filtrated.

Then a deproteinization using a protease of the type II from Aspergillus Orizae in 0.1M NaCl and 0.15 M ethylenediaminotetracetic acid (EDTA) at pH 8 containing 0.5% sodium dodecyl sulfate (SDS) (10 mg/l of filtrate) at 37° C. for 90 minutes is performed. The solution is ultrafiltrated on a SS 316 module with a nominal cut off membrane of 10,000 D with 2 extractions with 1M NaCl and washed with water until the absorbance disappears in the ultrafiltrate. K5 polysaccharide is then precipitated with acetone and a yield of 850 mg/l of fermentor is obtained. The purity of the polysaccharide is measured by uronic acid determination (carbazole method), proton and carbon NMR, UV and protein content. The purity is above 80%.

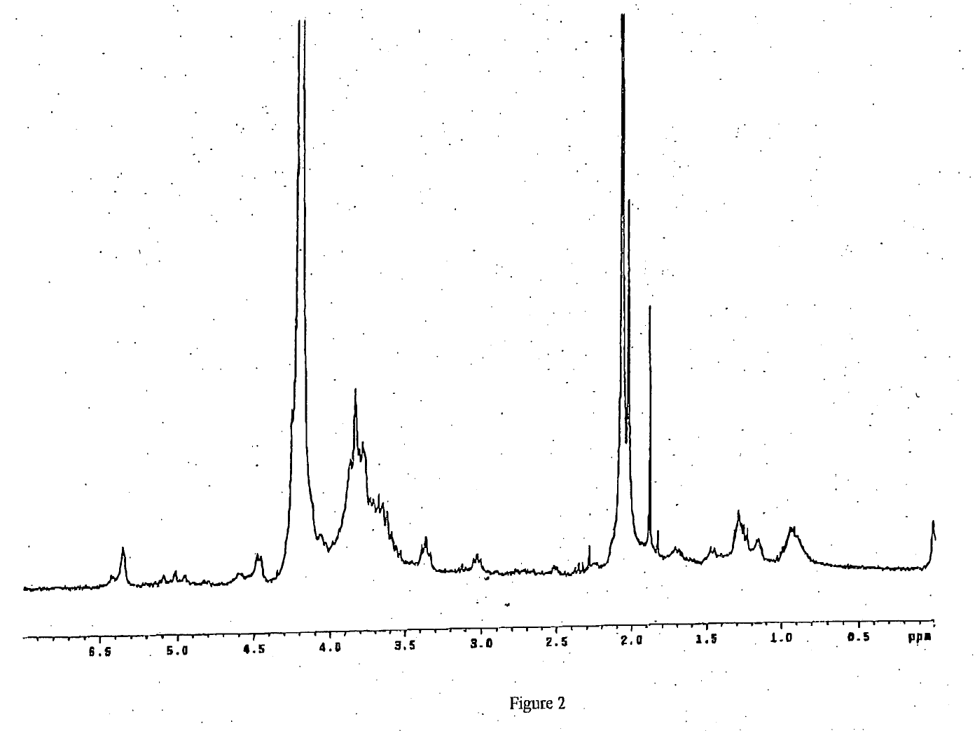

The so obtained polysaccharide is composed of two fractions with different molecular weight, 30,000 and 5,000 D respectively as obtained from the HPLC determination using a 75 HR Pharmacia column and one single fraction with retention time of about 9 minutes using two columns of Bio-sil SEC 250 in series (BioRad) and Na₂SO₄ as mobile phase at room temperature and flow rate of 0.5 ml/minute. The determination is performed against a curve obtained with heparin fractions with known molecular weight. The proton NMR is shown in FIG. 2. Such a K5 polysaccharide may be used as starting material for the process of the present invention because its purity is sufficient to perform said process. Advantageously, this starting material is previously purified. A suitable purification of K5 is obtained by treatment with Triton X— 100.

Typically, Triton X-100 is added to a 1% aqueous solution of the already sufficiently pure, above K5 polysaccharide to a concentration of 5%. The solution is kept at 55° C. for 2 hours under stirring. The temperature is raised to 75° C. and during the cooling to room temperature two phases are formed. On the upper phase (organic phase) the thermic treatment with the formation of the two phases is repeated twice. The aqueous phase containing the polysaccharide is finally concentrated under reduced pressure and precipitated with ethanol or acetone. The organic phase is discarded. The purity of the sample is controlled by proton NMR and results to be 95%

The yield of this treatment is 90%.

(b) N-deacetylation/N-sulfation. 10 g of purified K5 are dissolved in 100-2,000 ml of 2N sodium hydroxide and left to react at 40-80° C. for the time necessary to achieve the complete N-deacetylation, which is never above 30 hours. The solution is cooled to room temperature and the pH brought to neutrality with 6N hydrochloric acid.

The solution containing the K5-amine is kept at 20-65° C. and 10-40 g of sodium carbonate are added together with 10-40 g of a sulfating agent chosen among the available reagents such as the adduct pyridine.sulfur trioxide, trimethylamine.sulfur trioxide and the like. The addition of the sulfating agent is performed during a variable time till 12 hours. At the end of the reaction the solution is brought to room temperature, if necessary and to a pH of 7.5-8 with a 5% solution of hydrochloric acid.

The product is purified from salts with known technologies, for instance by diafiltration using a spirale membrane with 1,000 D cut off (prepscale cartridge—Millipore). The process is finished when the conductivity of the permeate is less than 1,000 μS, preferably less than 100 μS. The volume of the product obtained is concentrated till 10% polysaccharide concentration using the same filtration system as concentrator. If necessary the concentrated solution is dried with the known technologies.

The N-sulfate/N-acetyl ratio ranges from 10/0 to 7/3 measured by carbon 13 NMR.

(c) C5 Epimerization.

The step of C5 epimerization according to the present invention can be performed with the enzyme glucuronosyl C5 epimerase (also called C5 epimerase) in solution or its immobilized form.

C5 epimerization with the enzyme in solution.

From 1.2×10⁷ to 1.2×10¹¹ cpm (counts per minute) of natural or recombinant C5 epimerase, calculated according to the method described by Campbell P. et al. Analytical Biochemistry 131, 146-152 (1983), are dissolved in 2-2,000 ml of 25 mM Hepes buffer at a pH comprised between 5.5 and 7.4, containing 0.001-10 g of N-sulfate K5 and one or more of the ions chosen among barium, calcium, magnesium, manganese at a concentration ranging from 10 and 60 mM. The reaction is performed at a temperature ranging from 30 and 40° C., preferably 37° C. for 1-24 hours. At the end of the reaction the enzyme is inactivated at 100° C. for 10 minutes.

The product is purified by a passage on a diethylaminoethyl (DEAE)-resin or DEAE device Sartobind and unbound with 2M NaCl and finally desalted on a Sephadex G-10 resin or it is purified by precipitation with 2 volumes of ethanol and passage on a IR 120H⁺ resin to make the sodium salt.

The product obtained shows an iduronic acid/glucuronic acid ratio between 40:60 and 60:40 calculated by ¹H-NMR as already described in WO 96/14425. If the analyzed sample contains traces of divalent ions the peaks of iduronic acid can show a chemical shift in the ¹H-NMR spectrum.

C5 epimerization with immobilized enzyme.

The enzyme C5 epimerase, natural or recombinant, can be immobilized on different inert supports including resins, membranes or glass beads derivatized with reactive functional groups using the most common technologies of linkage for the enzymes such as cyanogen bromide, glutaraldehyde, carbodiimide or making the enzyme react with a ionic exchange resin or adsorbe on a membrane. According to the present invention the reactions of binding of the enzyme to the inert support are performed in presence of the substrate K5-N-sulfate to avoid the active site of the enzyme to link with loss of activity. The measure of the activity of the immobilized enzyme is performed by recirculating the amount of K5-N-sulfate that theoretically can be epimerized by that amount of cpm of immobilized enzyme onto a column of the immobilized enzyme in presence of 25 mM Hepes, 0.1M KCl, 0.01% Triton X-100 and 0.15 M EDTA pH 7.4 buffer at 37° C. overnight at a flow rate of 0.5 ml/minute. After the purification by DEAE chromatographic method and desalting on Sephadex G-10 the product is freeze dried and the content of iduronic acid is calculated by proton NMR.

The ratio iduronic acid/glucuronic acid shall be about 30/70.

A volume of 20-1,000 ml of 25 mM Hepes buffer at a pH between 6 and 7.4 containing one or more ions chosen among barium, calcium, magnesium, manganese at a concentration between 10 and 60 mM and 0.001-10 g K5-N-sulfate kept at a temperature between 30 and 40° C., are recirculated at a flow rate of 30-160 ml/hour for 1-24 hours in a column containing from 1.2×10⁷ to 3×10¹¹ cpm equivalents of the enzyme immobilized on the inert support kept at a temperature from 30 to 40° C. At the end of the reaction the sample is purified with the same methods indicated in the epimerization in solution.

The ratio iduronic acid/glucuronic acid of the product obtained ranges between 40:60 and 60:40.

d) Oversulfation

The solution containing the epimerized product of step c) at a concentration of 10% is cooled at 10° C. and passed through an IR 120H⁺ column or equivalent (35-100 ml). Both the column and the container of the product are kept at 10° C. After the passage of the solution the resin is washed with deionized water until the pH of the flow through is more than 6 (about 3 volumes of deionized water). The acidic solution is kept to neutrality with a tertiary or quaternary amine such as tetrabuthylammonium hydroxide (15% aqueous solution) obtaining the ammonium salt of the polysaccharide.

The solution is concentrated to the minimum volume and freeze dried. The product obtained is suspended in 20-500 ml of dimethyl formamide (DMF) or dimethyl sulfoxide (DMSO) and added with 15-300 g of a sulfating agent such as the adduct pyridine.SO₃ in the solid form or in solution of DMF or DMSO. The solution is kept at 20-70° C., preferably between 40 and 60° C. for 2-24 hours.

At the end of the reaction the solution is cooled to room temperature and added with acetone saturated with sodium chloride till complete precipitation.

The precipitate is separated from the solvent by filtration, solubilized into the minimum amount of deionized water (for instance 100 ml) and added with sodium chloride to obtain a 0.2M solution. The solution is brought to pH 7.5-8 with 2N sodium hydroxide and added with acetone till complete precipitation. The precipitate is separated from the solvent by filtration. The solid obtained is dissolved into 100 ml of deionized water and purified from the residual salts by ultrafiltration as described in step (b).

Part of the product is freeze dried for the structural analysis of the oversulfated product by ¹³C-NMR.

The content of sulfates per disaccharide of the product obtained is 2.0-3.5 calculated according to Casu B. et al. Carbohydrate Research 39 168-176 (1975). The position 6 of the glucosamine is sulfated at 80-95% and the position 2 is completely unsulfated. The other sulfate groups are present in position 3 of the amino sugar and 2 and 3 of the uronic acid.

(e) Selective O-desulfation.

The solution containing the product of the step (d) is passed through a cationic exchange resin IR 120H⁺ or equivalent (35-100 ml). After the passage of the solution the resin is washed with deionized water till the pH of the flow through is more than 6 (about 3 volumes of deionized water). The acidic solution is brought to neutrality with pyridine. The solution is concentrated to the minimum volume and freeze dried. The product obtained is treated with 20-2,000 ml of a solution of DMSO/methanol (9/1 V/V) and the solution is kept at 45-90° C. for 1-8 hours. Finally the solution is added with 10-200 ml of deionized water and treated with acetone saturated with sodium chloride to complete precipitation.

With the selective O-desulfation the sulfate groups in position 6 of the glucosamine are eliminated first, then the sulfates in position 3 and 2 of the uronic acid and finally the sulfate in position 3 of the amino sugar.

The solid obtained is purified by diafiltration as described in step (b).

Some of the sample is freeze dried for the structural analysis by ¹³C-NMR.

If the content of the sulfate groups in position 6 of the amino sugar is more than 60%, calculated as described by Casu B. et al. Arzneimittel-forschung Drug Research 33-1 135-142 (1983) the step g) is performed. Otherwise the next step is performed.

(f) Selective 6-O Sulfation (Optional).

The solution containing the product of step (e) is treated as described in step (d) to obtain the tertiary or quaternary ammonium salt, but performing the reaction at 20-25° C. The ammonium salt is suspended in 20-500 ml of DMF. The suspension is cooled to 0° C. and treated with an amount of sulfating agent such as the adduct pyridine.SO₃ calculated in function of the percentage of the sulfate in position 6 of the amino sugar to be inserted taking in account a minimum of 60% of 6-O-sulfation calculated as described above. The quantity of sulfating agent is comprised between two and ten equivalents of the hydroxyl groups to be sulfated. The sulfating agent is added one step or with several additions in a total time of 20 minutes.

The sulfating agent can be in powder or dissolved in a small amount of DMF. The solution is kept at 0-5° C. for 0.5-3 hours. The solution is then added with acetone saturated with sodium chloride in the right amount to complete the precipitation. The solid obtained is purified by diafiltration as described in step (b).

A small amount is freeze dried for the structural analysis by ¹³C-NMR.

If the content of 6-0 sulfate groups calculated by NMR is less than 60%, step (f) is repeated.

(g) N-sulfation

The solution obtained in step (f) or, if it is the case, in step (e) is treated as described in step (b) for the N-sulfation.

The product of the present invention obtained from step (d) to step (g) can be chemically depolymerized as described in WO 82/03627, preferably after step (g).

The glycosaminoglycans obtained by the process of the invention are characterized by proton and carbon 13 NMR and by biological tests like anti-Xa, aPTT, HCII, Anti-IIa and affinity for ATIII.

The product obtained can be fractionated by chromatography on resin or ultrafiltration obtaining low molecular weight fractions from 2,000 to 8,000 D and high molecular fractions from 25,000 to 30,000 D or it can be depolymerized with controlled known technologies such as nitrous acid deamination as described in WO 82/03627.

The typical characteristics of molecular weight and biological activity of the glycosaminoglycans obtained by the process of the invention (IN-2018 UF and IN-2018 LMW) are indicated in Table 1 in comparison with unfractionated heparin (Fourth International Standard) and LMW heparin (First International Standard).

The molecular weight is calculated as indicated in references. The molecular weights can be different from those of the starting polysaccharide due to the reaction conditions of the process of the invention.

The activities indicated in rows 1, 2, 3 and 4 are relative values in comparison with heparin taken as 100.

The data of column 5 and 6 represent the range of values for the products prepared according to the process of the present invention.

From the table it is evident that the product obtained with the present process shows comparable activity to the extractive heparin in the anti-Xa test (1) and reduced global anticoagulant activity (2) while the values of the tests which implies inhibition of thrombin are markedly higher (3,4). These characteristics are predictive of higher antithombotic properties and less side effects such as the bleeding effect of the product obtained compared to the extractive heparin.

TABLE 1
Biological activity of the product obtained by the described process:

| | | Unfractionated | | | |
|---|---|---|---|---|---|
| | | heparin | LMW heparin | | IN-2018 |
| | Sample | (4^{th} int. Standard) | (1^{st} int. Standard) | IN-2018 UF | LMW |
| 1 | Anti Xa | 100 | 84 | 70-250 | 40-100 |
| 2 | APTT | 100 | 30 | 40-90 | 25-80 |
| 3 | HCII | 100 | n.d. | 300-500 | 100-200 |
| 4 | Anti IIa | 100 | 33 | 100-600 | 20-210 |
| 5 | Mean molecular weight | 13,500 | 4,500 | 18,000-30,000 a) | 4,000-8,000 |
| | | | | 10,000-20,000 b) | |
| 6 | Affinity for ATIII | 32% | n.d. | 25-50 | 20-40 |

n.d.: not determined

### REFERENCES

1. Thomas D. P. et al. Thrombosis and Haemostasis 45 214 (1981) against the 4th International Standard of Heparin.
2. Andersson et al. Thrombosis Research 9 575 (1976) against the 4th International Standard of Heparin.
3. The test is performed mixing 20 μl of a solution of 0.05 PEU (Plasma Equivalent Unit)/ml of HCII (Stago) dissolved in water with 80 μl of a solution of the sample under examination at different concentrations and 50 μl of Thrombin (0.18 U/ml-Boheringer) in 0.02M tris buffer pH 7.4 containing 0.15 M NaCl and 0.1% PEG-6,000. The solution is incubated for 60 seconds at 37° C., then 50 μl of 1 mM chromogenic substrate Spectrozyme (American Diagnostic) are added. The reaction is continuously recorded for 180 seconds with determinations every second at 405 nm using an automatic coagulometer ACL 7000 (Instrumentation Laboratory).
4. Test is performed mixing 30 μl of a solution containing 0.5 U/ml of ATIII (Chromogenix) dissolved in 0.1M tris buffer pH 7.4 with 30 μl of a solution of the sample under examination at different concentrations and 60 μl of thrombin (5.3 nKat (Units of Enzymatic Activity)/ml-Chromogenix) in 0.1 M tris buffer pH 7.4. The solution is incubated for 70 seconds at 37° C., then 60 μl of 0.5 mM chromogenic substrate S-2238 (Chromogenix) in water are added. The reaction is continuously recorded for 90 seconds with determinations every second at 405 nm using an automatic coagulometer ACL 7000 (Instrumentation Laboratory).
5. Harenberg and De Vries J. Chromatography 261 287-292 (1983)
a) using a single column (Pharmacia 75HR)
b) using two columns (BioRad Bio-sil SEC250)
6. Hook M. et al. Febs Letters 66 90-93 (1976).

Due to their characteristics the glycosaminoglycans of the present invention can be used alone or in combination with acceptable pharmaceutical eccipients or diluents, for the anticoagulant and antithrombotic treatment.

In consequence the present invention also comprises the compositions containing a suitable amount of said glycosaminoglycans in combination with pharmaceutically acceptable excipients or diluents.

Finally the present invention refers to the effective amount of said glycosaminoglycans for the anticoagulant and antithrombotic treatment.

According to an advantageous method, in a process for the preparation of K5 glycosaminoglycans comprising the steps (i)-(vi) above it is possible to modulate the activity of the obtained final compound by controlling the reaction time of step (iv), at a given temperature.

Thus, more particularly, the present invention provides a process for the preparation of K5 glycosaminoglycans comprising the steps of (i) N-deacetylation/N-sulfation of the polysaccharide K5, (ii) partial C-5 epimerization of the carboxyl group of the glucuronic acid moiety to the corresponding iduronic acid moiety, (iii) oversulfation, (iv) selective O-desulfation, (v) optional selective 6-O-sulfation, and (vi) N-sulfation, in which step (iv) comprises treating the oversulfated product obtained at the end of step (iii) with a mixture methanol/dimethyl sulfoxide for a period of time of from 135 to 165 minutes.

Preferably, said period of time is of about 150 minutes

The product of the present invention obtained from step (ii) to step (vi) can be chemically depolymerized as described in WO 82/03627, preferably after step (vi).

According to a preferred embodiment, the treatment of the oversulfated product obtained at the end of step (iii) with a mixture methanol/dimethyl sulfoxide is made for a period of time of about 150 minutes at a temperature of about 60° C.

According to this advantageous method, from the oversulfated products prepared according to steps (i)-(iii) new glycosaminoglycans are obtained which show the best antithrombotic activity and a bleeding potential lower than that of any other heparin-like glycosaminoglycan.

Particularly interesting K5 glycosaminoglycans are obtained according to this advantageous method if, in addition, the partial epimerization of step (ii) gives at least 40% of iduronic acid moiety, the oversulfation of step (iii) is carried out in an aprotic solvent at a temperature of 40-60° C. for 10-20 hours and step (v) of selective 6-O-sulfation is actually performed.

Thus, it is a further object of the present invention to provide a process for the preparation of novel glycosaminoglycans, which comprises
(i) reacting K5 with a N-deacetylating agent, then treating the N-deacetylated product with a N-sulfating agent;
(ii) submitting the K5-N-sulfate thus obtained to a C5-epimerization by glucuronosyl C5 epimerase to obtain an epiK5-N-sulfate in which the iduronic/glucuronic ratio is from 60/40 to 40/60;
(iii) converting the epiK5-N-sulfate, having a content of 40 to 60% iduronic acid over the total uronic acids, into a tertiary amine or quaternary ammonium salt thereof, then treating the salt thus obtained with an O-sulfating agent in an aprotic polar solvent at a temperature of 40-60° C. for 10-20 hours;
(iv) treating an organic base salt of the O-oversulfated product thus obtained with a mixture dimethyl sulfoxide/methanol at 50-70° C. for 135-165 minutes to perform partial O-desulfation;
(v) treating an organic base salt of the partially O-desulfated product thus obtained with an O-sulfating agent at a temperature of 0-5° C. to perform a 6-O-sulfation;
(vi) treating the product thus obtained with a N-sulfating agent; whatever product obtained at the end of one of steps (ii) to (vi) being optionally submitted to a depolymerization.

K5 used as starting material may be whatever product as obtained by fermentation of wild or cloned K5 producing Escherichia coli strains. In particular, one of the above-mentioned K5 may be employed, advantageously one of those illustrated by M. Manzoni et al. Journal Bioactive Compatible Polymers, 1996, 11, 301-311 or in WO 01/02597, preferably previously purified.

Advantageous K5 starting materials have a low molecular weight, particularly with a distribution from about 1,500 to about 15,000, advantageously from about 2000 to about 9,000 with a mean molecular weight of about 5,000, or a higher molecular weight, particularly with a distribution from about 10,000 to about 50,000, advantageously from about 20,000 to about 40,000 with a mean molecular weight of about 30,000. Preferably, starting K5 has a molecular weight distribution from about 1,500 to about 50,000, with a mean molecular weight of 20,000-25,000. All the molecular weights are expressed in Dalton (D). The molecular weight of K5 and of its hereinbelow described derivatives is intended as calculated by using heparin fractions having a known molecular weight as standards.

In step (i), the starting K5 is submitted to a N-deacetylation and subsequent N-sulfation which are carried out by methods known per se, in particular as illustrated above for step (b) of N-deacetylation/N-sulfation.

Step (ii) may be performed with the enzyme glucuronosyl C5 epimerase (also called C5-epimerase) in solution or its immobilized form, in particular as set forth above for step (c) of C5 epimerization. According to a preferred embodiment, said C5-epimerization is performed with the enzyme in its immobilized form and comprises recirculating 20-1,000 ml of a solution of 25 mM Hepes at pH of from 6 to 7.4 containing 0.001-10 g of K5-N-sulfate and one of said cations at a concentration between 10 and 60 mM through a column containing from 1.2×10⁷ to 3×10¹¹ cpm of the immobilized enzyme on an inert support, said pH being about 7 and said C5 epimerization being performed at a temperature of about 30° C. by recirculating said solution with a flow rate of from 30 to 220 ml/hour, preferably of about 200 ml/hour for a time of about 24 hours, when the enzyme is a recombinant one.

Step (iii), consisting of an O-oversulfation, is carried out by previously converting the epiK5-N-sulfate into a salt thereof with tertiary amine or quaternary ammonium hydroxide and then by treating said salt with an O-sulfating agent at a temperature of 40-60° C. for 10-20 hours. Typically, the solution containing the epimerized product of step (ii) at a concentration of 10% is treated as illustrated above for step (d) of oversulfation, in particular by heating a solution of the above salt in DMF or DMSO at 20-70° C. for 2-24 hours, preferably at 40-60° C. for 15-20 hours.

Part of the product obtained is freeze dried for the structural analysis of the oversulfated product by ¹³C-NMR. The content of sulfates per disaccharide of the product obtained is 2.8-3.5 calculated according to Casu B. et al. Carbohydrate Research 1975, 39, 168-176. The position 6 of the glucosamine is sulfated at 80-95% and the position 2 is completely unsulfated. The other sulfate groups are present in position 3 of the amino sugar and in positions 2 and 3 of the uronic acid.

Step (iv), consisting of a selective O-desulfation, is the key step of the process of the present invention, because it allows the preparation, at the end of step (vi), of glycosaminoglycans that, after depolymerization, give low molecular weight products substantially maintaining a high antithrombin activity. Typically, the solution containing the product of step (iii) is passed through a cationic exchange resin IR 120H⁺ or equivalent (35-100 ml). After the passage of the solution, the resin is washed with deionized water till the pH of the flow through is more than 6 (about 3 volumes of deionized water). The acidic solution is brought to neutrality with pyridine. The solution is concentrated to the minimum volume and freeze dried. The product obtained is treated with 20-2,000 ml of a solution of DMSO/methanol (9/1 V/V) and the solution is kept at 50-70° C. for 135-165 minutes, preferably at about 60° C. for about 150 minutes. Finally the solution is added with 10-200 ml of deionized water and treated with acetone saturated with sodium chloride to complete the precipitation.

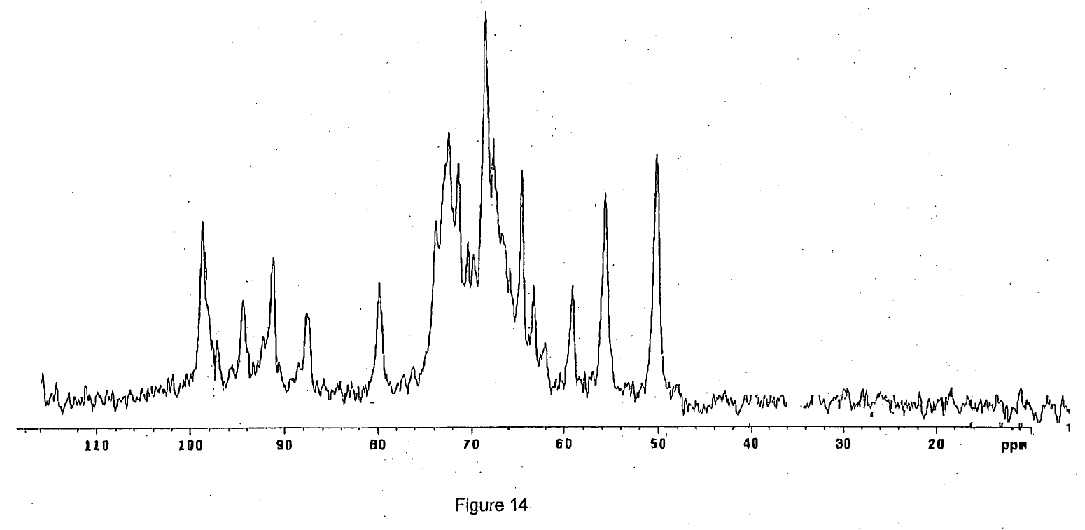

By the selective O-desulfation, sulfate groups in position 6 of the glucosamine are eliminated first, then the sulfate groups in position 3 and 2 of the uronic acid and finally the sulfate group in position 3 of the amino sugar. The ¹³C-NMR spectrum of the sample obtained (FIG. 14) shows the complete N-desulfation of the glucosamine residue (signal at 56 ppm) and the almost complete 6-0 desulfation with the decreasing of the signal at 67.6 ppm and the appearance of the signal at 62.2 ppm. The signals at 65 and 86 ppm show the 2-0 sulfated iduronic acid and the 3-0 sulfated glucuronic acid respectively. The solid obtained is purified by diafiltration according to known methods, for instance by using a spirale membrane with 1,000 D cut off (prepscale cartridge—Millipore). The process is finished when the conductivity of the permeate is less than 1,000 μS, preferably less than 100 μS. The volume of the product obtained is concentrated till 10% polysaccharide concentration using the same filtration system as concentrator. If necessary, the concentrated solution is dried by conventional technologies.

Step (v), consisting of a 6-O-sulfation, must also be carried out if, after a depolymerization step following step (vi) below, compounds having a high antithrombin activity, anti-Xa, HCII activities as high as those of heparin and a low aPTT are desired. The selective 6-O-sulfation is carried out by converting the selectively O-desulfated product into a tertiary or quaternary salt thereof and treating said salt with an O-sulfating agent at low temperature, more particularly at 0-5° C. for 0.5-3 hours. Typically, the 6-O-sulfation is carried out as illustrated above for step (f) of O-sulfation. The solid obtained is purified by diafiltration as described in step (iv). A small amount is freeze dried for the structural analysis by ¹³C-NMR. If the content of 6-O sulfate groups calculated by NMR, as described by Casu et al. Arzneimittel-Forschung Drug Research, 1983, 33, 135-142, is less than about 85%, step (v) is repeated.

Step (vi) must be performed because a non-negligeable percent of N-sulfate groups is lost during the O-oversulfation step. Thus, the solution obtained in step (v) is treated as described in step (i) for the N-sulfation in order to isolate the epiK5-N,O-sulfate of the invention.

Whatever high molecular weight product obtained at the end of one of steps (ii) to (vi) may be chemically depolymerized in order to obtain, as final products, low molecular weight glycosaminoglycans having high antithrombin activity, anti-Xa and HCII activities of the same order of those of standard heparin and an aPTT activity lower than that of standard heparin. This activity profile is unexpected because low molecular weight glycosaminoglycans obtained according to a process involving steps (i)-(vi), in which step (iv) is carried out under not controlled time conditions, said process being followed by a depolymerization, showed a severe lowering of all of the biological activities.

Generally, the process of the present invention is performed by carrying out steps (i)-(vi) sequentially and submitting the high molecular weight epiK5-N,O-sulfate obtained at the end of step (vi) to depolymerization. Of course, such a depolymerization is not necessary to prepare a low molecular weight C5-epimerized N,O-sulfate K5 if, as starting material, a low molecular weight fraction of K5, optionally previously purified, is used as starting material.

The depolymerization may be carried out according to the known methods for the depolymerization of heparin, for example by nitrous acid and subsequent reduction with sodium borohydride (WO 82/03627-EP 37319), by sodium periodate (EP 287477), by free radicals (EP 121067) or by β-elimination (EP 40144), in order to obtain, as final product, a glycosaminoglycan constituted by a mixture of chains in which at least 80% of said chains have a molecular weight distribution ranging from about 2,000 to about 10,000 with a mean molecular weight of from about 4,000 to about 8,000.

The glycosaminoglycans obtained by the process of the invention are characterized by proton and carbon 13 NMR and by biological tests like anti-Xa, aPTT, HCII, Anti-IIa and affinity for ATIII. As already mentioned above, the sulfation degree, namely the number of sulfate groups per disaccharide unit expressed as sulfate/carboxyl ratio (SO₃⁻/COO⁻), is determined as described by Casu et al., Carbohydrate Research, 1975, 39, 168-176.

The product obtained at the end of step (vi), without any depolymerization, may also be fractionated by chromatography on resin or ultrafiltration to obtain low molecular weight fractions of from 2,000 to 8,000 D and high molecular weight fractions of from 25,000 to 30,000 D.

The novel C5 epimerized N,O-sulfate K5 glycosaminoglycans (epiK5-N,O-sulfates) obtained at the end of the process of the present invention are generally isolated in form of their sodium salt. Said sodium salt may be converted into another salt. Said other salt may be another alkaline metal salt or an alkaline-earth metal, ammonium, tetra(C₁-C₄)alkylammonium, aluminium or zinc salt.

The products obtained by the process of the present invention show comparable activity to the extractive heparin in the anti-Xa test and reduced global anticoagulant activity (aPTT method) while the values of the tests involving inhibition of thrombin, heparin cofactor II (HCII) and anti-IIa activities, are of the same order as or markedly higher than those of standard heparin. These characteristics of the product obtained are predictive of better coagulation controlling and antithrombotic properties and lower side effects, such as bleeding effect, than those of commercial heparins and of other known anticoagulant glycosaminoglycans.

Thus it is a further object of the present invention to provide novel epiK5-N,O-sulfates obtainable by a process which comprises
(i) reacting K5 with a N-deacetylating agent, then treating the N-deacetylated product with a N-sulfating agent;
(ii) submitting the K5-N-sulfate thus obtained to a C5-epimerization by glucuronosyl C5 epimerase to obtain a C5-epimerized K5-N-sulfate in which the iduronic/glucuronic ratio is from 60/40 to 40/60;
(iii) converting the epiK5-N-sulfate, having a content of 40 to 60% iduronic acid over the total uronic acids, into a tertiary amine or quaternary ammonium salt thereof, then treating the salt thus obtained with an O-sulfating agent in an aprotic polar solvent at a temperature of 40-60° C. for 10-20 hours;
(iv) treating an organic base salt of the O-oversulfated product thus obtained with a mixture dimethyl sulfoxide/methanol at 50-70° C. for 135-165 minutes to perform a partial O-desulfation;
(v) treating an organic base salt of the partially O-desulfated product thus obtained with an O-sulfating agent at a temperature of 0-5° C. to perform a 6-O-sulfation;
(vi) treating the O-sulfated product thus obtained with a N-sulfating agent;
   whatever product obtained at the end of one of steps (ii) to (vi) being optionally submitted to a depolymerization and the sodium salt of the end product being optionally converted into another salt.

Particularly advantageous epiK5-N,O-sulfate glycosaminoglycans are those obtainable by the above process, in which step (iv) is carried out in a 9/1 (V/V) dimethyl sulfoxide/methanol mixture at about 60° C. for about 150 minutes.

A preferred class of glycosaminoglycans derived from K5 is obtainable by performing steps (i)-(vi) above on a previously purified K5, whereby step (iv) is carried out by heating at about 60° C. in a 9/1 dimethyl sulfoxide/methanol mixture for about 150 minutes, and optionally submitting the epiK5-N,O-sulfate thus obtained to a nitrous acid depolymerization and to a subsequent sodium borohydride reduction.

Advantageously, said other salt is another alkaline metal, an alkaline-earth metal, ammonium, tetra(C₁-C₄)alkylammunium, aluminium or zinc salt.

The epiK5-N,O-sulfate glycosaminoglycans obtainable according to the process comprising steps (i)-(vi) above, including the optional depolymerization and salt formation, have the structure I as illustrated hereinbelow.

Thus, it is another object of the present invention to provide novel glycosaminoglycans constituted by a mixture of chains in which at least 90% of said chains has the formula I 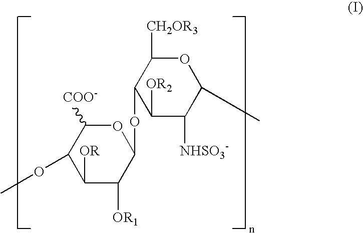
wherein 40-60% of the uronic acid units are those of iduronic acid, n is an integer of from 3 to 100, R, R₁, R₂ and R₃ represent a hydrogen atom or a SO₃⁻ group and from about 65% to about 50% of R, R1, R2 and R3 being hydrogen and the remaining being SO₃⁻ groups distributed as follows
R₃ is from about 85% to about 95% SO₃⁻;
R₂ is from about 17 to about 21% SO₃⁻;
R₁ is from about 15 to about 35% SO₃⁻ in iduronic units and 0 to 5% SO₃⁻ in glucuronic units;
R is from about 20 to about 40% SO₃⁻ in glucuronic units and 0 to 5% in iduronic units;
the sum of the SO₃⁻ percent in R₁, glucuronic units, and in R, iduronic units, is from 3 to 7%;
   R₁ and R being not simultaneously SO₃⁻ and being both hydrogen in 25-45% of the uronic acid units; the sulfation degree being from about 2.3 to about 2.9, and the corresponding cation being a chemically or pharmaceutically acceptable one.

In this context, the expression “chemically acceptable” is referred to a cation which is useful for the chemical syntheses, such as ammonium or tetra(C₁-C₄)alkylammonium ion, or for the purification of the products.

Advantageously, from about 60% to about 55% of R, R₁, R₂ and R₃ are hydrogen and the remaining are SO₃⁻ groups for a sulfation degree of from about 2.4 to about 2.7.

Advantageous low molecular weight glycosaminoglycans are constituted by a mixture of chains in which at least 80% of said chains have the formula I wherein n is from 3 to 15.

Among these low molecular weight glycosaminoglycans, those in which said mixture of chains has a molecular weight distribution ranging from about 2,000 to about 10,000, with a mean molecular weight of from about 4,000 to about 8,000 are particularly advantageous.

Preferred glycosaminoglycans of this class is constituted by a mixture of chains with a mean molecular weight of from about 6,000 to about 8,000, in which at least 90% of said chains have the formula I above, wherein about 55% of the uronic acid units are those of iduronic acid and R₃ is from about 85% to about 90% SO₃⁻; R₂ is about 20% SO₃⁻; R₁ is from about 25% to about 30% SO₃⁻ in iduronic units and 0 to about 5% SO₃⁻ in glucuronic units; R is from about 30% to about 35% SO₃⁻ in glucuronic units and in R, iduronic units, is about 5%; R₁ and R being not simultaneously SO₃⁻ and being both hydrogen in from about 30% to about 40% of the uronic acid units; the sulfation degree being from about 2.5 to about 2.7, the corresponding cation being a chemically or pharmaceutically acceptable one.

A particularly preferred low molecular weight glycosaminoglycan of this class is constituted by a mixture of chains with a mean molecular weight of about 7,000, preferably of 7,400, in which at least 90% of said chains have the formula I above, wherein about 55% of the uronic acid units are those of iduronic acid and
R₃ is about 85% SO₃⁻;
R₂ is about 20% SO₃⁻;
R₁ is about 25% SO₃⁻ in iduronic units and 0 to about 5% SO₃⁻ in glucuronic units;
R is about 30% SO₃⁻ in glucuronic units and 0 to about 5% in iduronic units;
the sum of the SO₃⁻ percent in R₁, glucuronic units and in R, iduronic units, is about 5%;
   R₁ and R being not simultaneously SO₃⁻ and being both hydrogen in about 40% of the uronic acid units; the sulfation degree being about 2.55, the corresponding cation being a chemically or pharmaceutically acceptable one.

The percent of the sulfate groups in the 3-position of the glucuronic acid and 2-position of iduronic acid have been determined by ¹³C-NMR on the compound obtained after step (iv), by measuring the areas of the peaks at 86 and 65 ppm, attributable to the 3-O-sulfo-glucuronic acid unit and, respectively, to the 2-O-sulfo-iduronic acid unit and by considering that the percent of the added SO₃ groups in step (vi), in respect of the total amount of sulfate groups, is negligible.

Advantageous chemically and pharmaceutically acceptable cations are those derived from alkaline metals, alkaline-earth metals, ammonium, tetra(C₁-C₄)alkylammonium, aluminium and zinc, sodium and calcium ions being particularly preferred.

Advantageous high molecular weight glycosaminoglycans are constituted by a mixture of chains in which at least 80% of said chains have the structure I wherein n is from 20 to 100.

Among these glycosaminoglycans, those in which said mixture of chains has a molecular weight distribution ranging from about 9,000 to about 60,000, with a mean molecular weight of from about 12,000 to about 30,000 are preferred.

A particularly preferred high molecular weight glycosaminoglycan of this class is constituted by a mixture of chains with a mean molecular weight of 14,000-16,000, in which at least 90% of said chains have the formula I above, wherein about 55% of the uronic acid units are those of iduronic acid and
R₃ is from about 85% to about 90% SO₃⁻;
R₂ is about 20% SO₃⁻;
R₁ is from about 25% to about 30% SO₃⁻ in iduronic units and 0 to about 5% SO₃⁻ in glucuronic units;
R is from about 30% to about 35% SO₃⁻ in glucuronic units and 0 to about 5% in iduronic units;
the sum of the SO₃⁻ percent in R₁, glucuronic units and in R, iduronic units, is about 5%;
   R₁ and R being not simultaneously SO₃⁻ and being both hydrogen in from about 30 to about 40% of the uronic acid units; the sulfation degree being from about 2.5 to about 2.7, the corresponding cation being a chemically or pharmaceutically acceptable one.

The novel glycosaminoglycans obtainable by the process sequentially comprising steps (i)-(vi) above, including optional depolymerization and salt formation, in particular those constituted by a mixture of chains in which at least 90% of said chains has the formula L in which R, R₁, R₂ and R₃ are as defined above and the corresponding cation being a chemically or pharmaceutically acceptable one, preferably a sodium or calcium ion, show interesting biological activities on the coagulation parameters. Particularly, said novel glycosaminoglycans exhibit anti-Xa and HCII activities at least of the same order of that of standard heparin, an anti-IIa (antithrombin) activity higher than that of standard heparin and a global anticoagulant activity (expressed as aPTT titre) lower than that of standard heparin. More particularly, said novel glycosaminoglycans show ratios anti-Xa/aPTT, HCII/aPTT and anti-IIa/anti-Xa of from 1.5 to 3 and a HCII/antiXa ratio of from 1 to 3.

According to a further, particularly advantageous embodiment, the present invention provides a process for the preparation of glycosaminoglycans derived from K5 comprising the following steps: (i) N-deacetylation/N-sulfation of the polysaccharide K5, (ii) partial C-5 epimerization of the carboxyl group of the glucuronic acid moiety to the corresponding iduronic acid moiety, (iii) oversulfation, (iv) selective O-desulfation, (v) selective 6-O-sulfation, and (vi) N-sulfation, wherein the epiK5-N-sulfate obtained at the end of step (ii) is submitted to a depolymerization step (ii′) before steps (iii)-(vi), to obtain depolymerized-LMW-epiK5-N,O-sulfates.

Preferably, the depolymerization step (ii′) consists of a nitrous depolymerization followed by a reduction for example with sodium borohydride.

Thus, it is a further object of the present invention to provide a process for the preparation of novel depolymerized-LMW-epiK5-N,O-sulfates having a sulfation degree of from 2.3 to 2.9, and of their pharmaceutically acceptable salts, which comprises
(i) reacting K5 with a N-deacetylating agent, then treating the N-deacetylated product with a N-sulfating agent;
(ii) submitting the K5-N-sulfate thus obtained to a C5-epimerization by glucuronosyl C5 epimerase to obtain an epiK5-N-sulfate in which the iduronic/glucuronic ratio is from 60/40 to 40/60;
(ii′) submitting the epiK5-N-sulfate having a content of 40% to 60% iduronic acid over the total uronic acids thus obtained to a nitrous depolymerization followed by a reduction, normally with sodium borohydride, to obtain a depolymerized-LMW-epiK5-N-sulfate;
(iii′) converting the depolymerized-LMW-epiK5-N-sulfate, having a content of 40% to 60% iduronic acid over the total uronic acids, into a tertiary amine or quaternary ammonium salt thereof, then treating the salt thus obtained with an O-sulfating agent in an aprotic polar solvent at a temperature of 40-60° C. for 10-20 hours;
(iv′) treating an organic base salt of the depolymerized-LMW-epiK5-amine-O-oversulfate thus obtained with a mixture dimethyl sulfoxide/methanol to perform a partial O-desulfation;
(v′) treating an organic base salt of the partially O-desulfated product thus obtained with an O-sulfating agent at a temperature of 0-5° C. to perform a 6-O-sulfation to obtain a depolymerized-LMW-epiK5-amine-O-sulfate containing at least 80% 6-O-sulfate; and
(vi′) treating the depolymerized-LMW-epiK5-amine-O-sulfate containing at least 80% 6-O-sulfate thus obtained with a N-sulfating agent to perform N-sulfation.

The depolymerized-LMW-epiK5-N,O-sulfate thus obtained, normally having a sulfation degree from 2.3 to 2.9 and a mean molecular weight of from 1,500 to 12,000, is isolated as sodium salt which is optionally converted into another pharmaceutically acceptable salt thereof.

Salts with alkaline metals, in particular sodium or potassium, with alkaline-earth metals, in particular calcium and magnesium, with aluminum and with zinc are preferred pharmaceutically acceptable salts.

The depolymerized-LMW-epiK5-N,O-sulfates and their pharmaceutical acceptable salts, obtainable by this process, represent a further embodiment of the present invention. The preferred salts are the above mentioned ones, in particular the sodium and calcium salts.

Steps (i) and (ii) are carried out as illustrated above. In particular, the C5-epimerization reaction of step (ii) is carried out by recirculating 20-1,000 ml of a 25 mM HEPES solution at a pH of approximately 7 containing 0.001-10 g of substrate (K5-N-sulfate) and a cation selected among calcium, magnesium, barium and manganese at a concentration of from 10 to 60 mM through a column containing from 1.2×10⁷ to 3×10¹¹ cpm of the immobilized enzyme, by maintaining the pH at approximately 7 at approximately 30° C., at a flow of 30-220 ml/hour for a period of time of 12-24 hours, advantageously 15-24 hours. Preferably said solution is recirculated at a flow of approximately 200 ml/hour overnight (15-20 hours). The product obtained is purified and separated according to known methods, for example by ultrafiltration and precipitation with ethanol. In the product thus obtained, consisting of epiK5-N-sulfate, the percentage of epimerization, in practice the amount of iduronic units in respect of the glucuronic ones, is calculated by using ¹H-NMR according to the method described in WO 96/4425.

Step (ii′) is carried out by submitting the epiK5-N-sulfate obtained at the end of step (ii) to a nitrous depolymerization followed by a reduction normally with sodium borohydride. The epiK5-N-sulfates used for the preparation of the above starting depolymerized-LMW-epiK5-N-sulfates are those having an iduronic acid content of 40-60% and contain at least 95%, preferably 100% N-sulfate groups.

The nitrous depolymerization reaction is carried out according to known methods of depolymerization of heparin by nitrous acid, for example according to the method described in EP 37319, in WO 82/03627 or according to the depolymerization method of a K5-N-sulfate described in EP 544592, but starting from an epiK5-N-sulfate containing from 0 to no more than 5% acetyl groups. The depolymerization, performed with sodium nitrite and hydrochloric acid on an epiK5-N-sulfate is followed by a reduction in situ with sodium borohydride.

In practice, a cold aqueous solution of epiK5-N-sulfate is brought to acid pH (approximately 2) with hydrochloric acid and, still in the cold, treated with sodium nitrite, by maintaining the temperature (approximately 4° C.) and the pH (approximately 2) constant and, upon termination of the depolymerization (approximately 15-30 minutes) the solution is neutralized with sodium hydroxide and treated, still at approximately 4° C., with an aqueous solution of sodium borohydride. Upon termination of the reduction (approximately 4 hours) the excess sodium borohydride is destroyed with hydrochloric acid, the solution is neutralized with sodium hydroxide and the depolymerized (and reduced) product is isolated according to known methods, for example by straightforward precipitation with ethanol or acetone.

The product obtained at the end of the depolymerization is a LMW-epiK5-N-sulfate. By appropriately controlling the depolymerization reaction, in particular using different amounts of sodium nitrite/hydrochloric acid, there are obtained LMW-epiK5-N-sulfates having a mean molecular weight in the entire interval of from approximately 1,500 to approximately 12,000, advantageously from approximately 1,500 to approximately 10,000, preferably from approximately 1,500 to approximately 7,500, calculated at the ¹³C-NMR spectrum by the integration of the signal attributed to the C2 of 2,5-anhydromannitol with that of the anomeric carbon of the glucosamine inside the polysaccharide chain.

According to a general manner of manufacture, starting for example from 1 g of epiK5-N-sulfate, the starting product is dissolved in 100-200 ml of deionized water and thermostated at 4° C. Then an amount of sodium nitrite is added so as to obtain the desired mean molecular weight. In order to obtain, for example, a LMW-epiK5-N-sulfate with a mean molecular weight of from about 2,000 to about 4,000 starting from an epiK5-N-sulfate having a mean molecular weight of about 20,000 (measured with the HPLC method equipped with a BioRad BioSil 250 column and using a heparin standard of known molecular weight), there will be required the addition of 330 to 480 mg of sodium nitrite dissolved in a 0.2% aqueous solution. The solution containing the epiK5-N-sulfate and the sodium nitrite, kept at 4° C., is brought to pH 2 by addition of 0.1 N HCl cooled to 4° C. It is left to react under slow stirring for 20-40 minutes, then it is neutralized with 0.1 N NaOH. The solution containing the product thus obtained is brought to room temperature and treated with a reducing agent such as for example sodium borohydride (250-500 mg dissolved in 50-100 ml of water) and left to react for 4-8 hours. The excess sodium borohydride is eliminated by adjusting the pH to 5-5.5 with 0.1 N HCl and letting the mixture to stand for a further 2-4 hours. At the end, the mixture is neutralized with 0.1 N NaOH and the product is recovered by precipitation with acetone or ethanol after having concentrated the product by evaporation under reduced pressure.

Analogously, the amounts of sodium nitrite can be determined which, starting from 1 g of epiK5-N-sulfate, allow the attainment of a depolymerized-LMW-epiK5-N-sulfate with a mean molecular weight from about 4,000 to about 12,000, advantageously from about 4,000 to about 7,500, in particular of 6,000-7,500.

The depolymerized-LMW-epiK5-N-sulfates thus obtained, with an iduronic acid content of from 40% to 60%, advantageously of 50-55% and preferably practically free of NH₂ and N-acetyl groups, having a mean molecular weight from approximately 1,500 to approximately 12,000, advantageously of from approximately 1,500 to approximately 10,000, preferably from approximately 1,500 to approximately 7,500 and their chemically or pharmaceutically acceptable salts are useful intermediates in the preparation of the depolymerized-LMW-epiK5-N,O-sulfates of the present invention.

Advantageously, said intermediates in the preparation of the depolymerized-LMW-epiK5-N,O-sulfates of the present invention are depolymerized-LMW-epiK5-N-sulfate-derivatives consisting of a mixture of chains in which at least 90% of said chains have the formula II 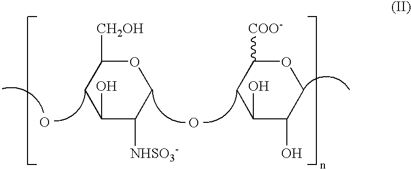
in which 40%-60%, preferably 50%-55% of the uronic units consist of iduronic acid, n is a integer from 2 to 20, advantageously from 3 to 15, and the corresponding cation is a chemically or pharmaceutically acceptable one.

In this context, the term “chemically” refers to a cation usable in chemical synthesis, such as sodium, ammonium, tetra(C₁-C₄)alkylammonium ions, or for the purification of the product.

Advantageous cations are those derived from alkaline metals, alkaline-earth metals, ammonium, tetra(C₁-C₄)alkylammonium, aluminum and zinc. Preferred cations are the sodium, calcium and tetrabutylammonium ions.

The depolymerized-LMW-epiK5-N-sulfates, consisting of a mixture of chains in which at least 90% of said chains have the formula II herein above, obtained by nitrous depolymerization of the corresponding epiK5-N-sulfates shown above and subsequent reduction for example with sodium borohydride, are particularly interesting intermediates. Among these, depolymerized-LMW-epiK5-N-sulfates consisting of a mixture of chains in which the preponderant species has the formula II′a 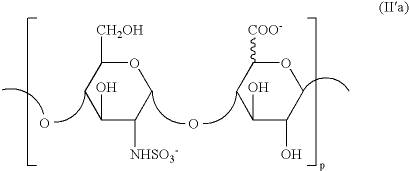
wherein 40%-60% of the uronic units are those of iduronic acid, p is a integer from 4 to 8 and the corresponding cation is a chemically or pharmaceutically acceptable one, are particularly advantageous. The mean molecular weight of these products is from about 2,000 to about 4,000.

The origin of these epiK5-N-sulfates from a step of nitrous depolymerization followed by a reduction with, for example, sodium borohydride involves, at the reducing end of the majority of the chains in said mixture of chains, the presence of a 2,5-anhydromannitol unit of structure (a) 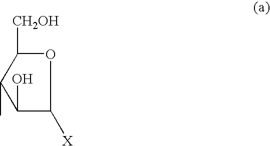
in which X represents a hydroxymethyl group. Therefore, the reducing end of the majority of the chains is actually represented by the structure (b) 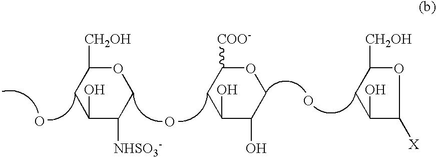
wherein X is as defined above.

Other particularly advantageous depolymerized-LMW-epiK5-N-sulfates intermediates according to the present invention consist of mixtures of chains in which the preponderant species is a compound of formula II′b 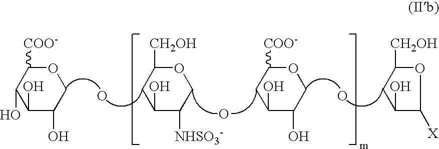
in which X is hydroxymethyl, m is 4, 5 or 6, the corresponding cation is a chemically or pharmaceutically acceptable ion and the glucuronic and iduronic units are present alternately, the non reducing end being a glucuronic or iduronic unit. In such a case the glucuronic/iduronic ratio is from 45/55 to 55/45, i.e. approximately 50/50.

Step (iii′) consists of an O-oversulfation of the depolymerized-LMW-epiK5-N-sulfates obtained at the end of step (ii′), which may be carried out according to anyone of the methods described in the literature, for example according to the Method C described by Casu et al., or as described above for step (iii), in order to obtain a depolimerized-LMW-epiK5-amine-O-oversulfate.

The origin of the depolymerized-LMW-epiK5-amine-O-oversulfates from depolymerized-LMW-epiK5-sulfates obtained by nitrous depolymerization and subsequent reduction with, for example, sodium borohydride, involves, at the reducing end of the majority of the chains in said mixture of chains, the presence of a sulfated 2,5-anhydromannitol unit of structure (a′) 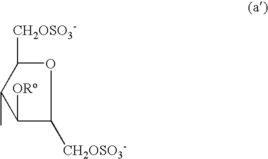
in which R° represents hydrogen or SO₃⁻.

Thus, the reducing end of the majority of the chains in said mixture of chain is represented by the structure (b′) 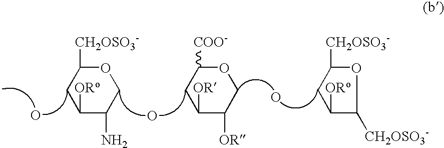
in which R°, R′ and R″ represent H or SO₃⁻ and the uronic unit can be glucuronic or iduronic.

By operating as described above, a solution containing the depolymerized-LMW-epiK5-N-sulfate at a concentration of 10% is cooled to 10° C. and then passed through a cationic exchange resin IR-120H⁺ or an equivalent thereof (35-100 ml). Both the column and the vessel containing the eluate are kept at 10° C. After the passage of the solution, the resin is washed with deionized water until the pH of the permeate is higher than 6 (about 3 volumes of deionized water). The acid solution is brought to neutrality with a tertiary amine or quaternary ammonium base such as for example tetrabutylammonium hydroxide (15% aqueous solution) to obtain the corresponding ammonium salt. The solution is concentrated to a minimum volume and freeze dryed. The obtained product is suspended in 20-500 ml of dimethyl formamide (DMF) or dimethyl sulfoxide (DMSO) and 15-300 g of a sulfating agent, such as the pyridine.SO₃ adduct, in solid form or dissolved in DMF or DMSO, are added thereto. The solution is maintained at 20-70° C., preferably at 40-60° C. for 2-24 hours.

A volume of water is added in order to stop the reaction, the pH is brought to neutrality with 1N NaOH. The sample is recovered by precipitation with a saturated solution of NaCl in acetone. The precipitate is separated from the solvent by filtration. The obtained solid is dissolved in 100 ml of deionized water and purified from the residual salts by ultrafiltration. The obtained product shows a sulfate/carboxyl ratio of from 2 to a maximum of 3.2, calculated according to Casu et al. Carbohydate Res. 1975, 39, 168-176. The position 6 of the amino sugar is 80-95% sulfated and the position 2 is not sulfated. The other sulfate groups are present on the position 3 of the amino sugar and in the positions 2 and 3 of the uronic acid.

A depolymerized-LMW-epiK5-amine-O-oversulfate having a higher sulfate/carboxyl ratio, namely of at least 3.4, advantageously of at least 3.5, more advantageously from 3.55 to 4, preferably from 3.55 to 3.8, is obtained by carrying out the above step (iii′) by
(iii′.1) treating a said depolymerized-LMW-epiK5-N-sulfate, in acidic form, with a tertiary or quaternary organic base, letting the reaction mixture to stand for a period of time of 30-60 minutes, maintaining the pH of the solution at a value of about 7 by addition of said tertiary or quaternary organic base and isolating its salt with said organic base;
(iii′.2) treating said organic base salt of said depolymerized-LMW-epiK5-N-sulfate with an O-sulfation agent under O-oversulfation conditions and isolating the depolymerized-LMW-epiK5-amine-O-oversulfate.

The depolimerized-LMW-epiK5-amine-O-oversulfate obtained at the end of step (iii′) or (iii′.1)+(iii′.2) has a sulfation degree of from 2 to 4 and a mean molecular weight of from about 2,500 to about 12,500, advantageously from about 2,500 to about 10,500, preferably from about 2,500 to about 8,000 and the corresponding cation is a chemically or pharmaceutically acceptable one.

As it can be noted, notwithstanding the addition of 1-3 SO₃⁻ groups per disaccharide, starting from a depolymerized-LMW-epiK5-N-sulfate having a mean molecular weight of from about 1,500 to about 12,000, a depolymerized-LMW-epiK5-amine-O-oversulfate with a mean molecular weight of from about 2,500 to about 12,500, namely slightly higher than that of the starting material instead of a theoretical molecular weight range of from about 2,000 to about 15,000, is obtained at the end of step (iii′). This decrease of the molecular weight is caused by a further depolymerization due to the strongly acidic medium in which step (iii′) or (iii′.1)+(iii′.2) is conducted.

The depolymerized-LMW-epiK5-amine-O-sulfates are advantageously formed of a mixture of chains wherein at least 90% of said chains have the formula III 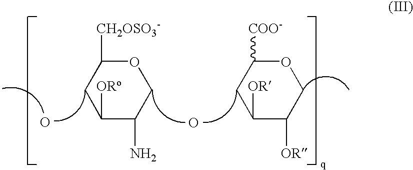
in which 40%-60%, preferably 50%-55%, of the uronic units are those of iduronic acid, R°, R′ e R″ represent hydrogen or a SO₃⁻ group, for a sulfation degree of from 2 to 4, q is an integer from 2 to 17, advantageously from 2 to 14, preferably from 2 to 11, presents an unit (a′) as defined above at the reducing end of the majority of its chains and the corresponding cation is a chemically or pharmaceutically acceptable one.

Depolymerized-LMW-epiK5-amine-O-oversulfates having a very high sulfation degree (at least 3.4, advantageously at least 3.5, more advantageously from 3.55 to 4, preferably from 3.55 to 3.8) obtainable according to the above mentioned steps (iii′.1)+(iii′.2) are formed by a mixture of chains wherein at least 90% of said chains have the formula III wherein 40%-60%, preferably 50%-55% of the uronic units are those of the iduronic acid, R° is at least 40%, advantageously 50%-80%, preferably about 65% SO₃⁻, R′ and R″ are both SO₃⁻ or one of them is hydrogen and the other is 5%-10% SO₃⁻ in glucuronic acid and 10%-15% SO₃⁻ in iduronic acid, q is as defined above and the corresponding cation is a chemically or pharmaceutically acceptable one.

In step (iv′), the selective O-desulfation of the depolymerized-LMW-epiK5-amine-O-oversulfate obtained at the end of step (iii′) or (iii′.1)+(iii′.2) is carried out by treatment of the depolymerized-LMW-epiK5-N-sulfate with a mixture DMSO/methanol 9/1, for example according to the methods described above or by A. Naggi et al., Carbohydrate Research, 2001, 336, 283-29.

In practice, a solution of the depolymerized-LMW-epiK5-amine-O-oversulfate obtained at the end of step (iii′) is passed onto a cationic exchange resin such as IR-120H+by washing with deionized water and the percolated solution is brought to pH from 6 to 7 with a tertiary amine or quaternary ammonium base such as pyridine. The salt of the depolymerized-LMW-epiK5-amine-O-oversulfate with the organic base, for example its pyridine salt, is isolated by freeze-drying the suitably concentrated solution. The obtained product is treated with a solution dimethysulfoxide/methanol about 9/1 (V/V) and the obtained solution is maintained at 45-90° C. for a period of time of from 1 to 8 hours, advantageously of from 2 to 4 hours. The partially O-desulfated product, consisting of a depolymerized-LMW-epiK5-amine-O-sulfate partially desulfated prevalently on the primary hydroxyls and on the hydroxyls of the uronic acids, is isolated by precipitation from the solution by addition of deionized water and, subsequently, of acetone, optionally containing sodium chloride in an amount until saturation.

According to a preferred embodiment, the mixture dimethyl sulfoxide/methanol about 9/1 (V/V) is previously heated to the desired temperature, the depolymerized-LMW-epiK5-amine-O-oversulfate salt is added thereto and the duration of the O-desulfation reaction is considered starting from the moment in that the whole of the reagents is at the previously selected temperature. The depolymerized-LMW-epiK5-amine-O-sulfate, partially desulfated prevalently on the primary hydroxyls and on the hydroxyls of the uronic acids, is isolated as described above. A little sample may be separated for the characterization and the remaining product is used for the subsequent 6-O-sulfation step (v′).

In step (v′), the precipitate from acetone is washed with acetone, dissolved in water and the solution is brought to a pH of about 7.5 with 2N NaOH, passed through a IR-120H⁺ resin, then neutralized with a tertiary amine or quaternary ammonium base such as pyridine or tetrabutylammonium hydroxide and the obtained salt is isolated by lyophilization. The 6-O-sulfation is carried out by dissolving the aforesaid salt in DMF and adding the sulfation agent, for example pyridine.SO₃, also dissolved in DMF, in an amount of 2.15 grams per gram of product (pyridine or tetrabutylammonium salt) to the solution. The reaction is carried out by maintaining the mixture at about 0° C. for about 60-120 minutes and the 6-O-sulfated product is isolated by neutralizing the solution with NaOH and by subsequent precipitation with acetone, optionally containing sodium chloride in an amount until saturation. The precipitation operation may be repeated several times. The 6-O-resulfated depolymerized-LMW-epiK5-amine-O-sulfate thus obtained has a 6-O-sulfate content of at least 80%. The 6-O-sulfation may be repeated.

In step (vi′), the 6-O-resulfated depolymerized-LMW-epiK5-O-sulfate is treated with a sulfation agent under the classical N-sulfation conditions. In particular, the operation is carried out by treating an aqueous solution of the 6-O-resulfated depolymerized-LMW-epiK5-O-sulfate obtained at the end of step (v′) with sodium carbonate and then with a sulfation agent such as pyridine.SO₃ at a temperature of 35-45° C. and the final product, consisting of the depolymerized-LMW-epiK5-N,O-sulfate, is isolated as sodium salt, for example by diafiltration. The N-sulfation reaction may be repeated.

The sodium salt of the depolymerized-LMW-epiK5-N,O-sulfate, which has a sulfation degree of from 2.3 to 2.9, may be converted into another pharmaceutical acceptable salt, such as that of another alkaline metal salt, of an alkaline-earth metal, of aluminum or of zinc according to known methods, for example by ionic exchange with a suitable resin, by precipitation with solvents or by ultrafiltration through suitable membranes. Advantageous salts are those of sodium, potassium, magnesium, calcium, aluminum and zinc. The sodium and calcium salts are preferred.

It is to be noted that the molecular weight of the new depolymerized-LMW-epiK5-N,O-sulfates obtained at the end of step (vi′) is approximately equal to that of the intermediate depolymerized-LMW-epiK5-N-sulfates due to the partial depolymerization occurring in the O-oversulfation step (iii′) or (iii′.1)+(iii′.2).

According to its most preferred embodiment, the present invention concerns depolymerized-LMW-epiK5-N,O-sulfates having a sulfation degree of from 2.3 to 2.9, advantageously from 2.5 to 2.9, preferably from 2.7 to 2.9, and a mean molecular weight of from about 1,500 to about 12,000, advantageously from about 1,500 to about 10,000, preferably from about 1,500 to about 8,000 and characterized by the presence of the structure (a′) at the reducing end of the majority of its chains, and their pharmaceutically acceptable salts. A depolymerized-LMW-epiK5-N,O-sulfate, or a pharmaceutically acceptable salt thereof, exhibiting an interesting antithrombotic activity, comparable with that of the LMWH but with a 2.5- to 4-fold lower risk to induce bleeding than LMWH does, has a mean molecular weight of about 6,000. Preferably, this depolymerized-LMW-epiK5-N,O-sulfate has a sulfation degree of from 2.7 to 2.9, a content of 80-95% in glucosamine 6-O-sulfate, of 95-100% in glucosamine N-sulfate, of 45-55% in glucosamine 3-O-sulfate, of 35-45% in glucuronic acid 3-O-sulfate, of 15-25% in iduronic acid 2-O-sulfate and presents an unity (a′) as defined above at the reducing end of the majority of its chains.

Advantageous depolymerized-LMW-epiK5-N,O-sulfates of the present invention consist of mixtures of chains in which at least 80% of said chains has the formula IV 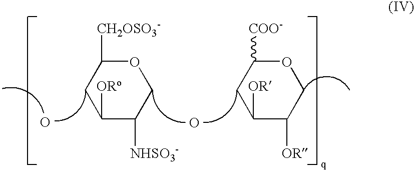
wherein the uronic units are 40%-60% those of iduronic acid, q is an integer from 2 to 17, advantageously from 2 to 14, preferably from 2 to 11, R°, R′ and R″ are hydrogen or SO₃—, for a sulfation degree of from 2.3 to 2.9, the reducing end of the majority of the chains in said mixture of chains presents a sulfated 2,5-anidromannitol unit of structure (a′) as defined above, and the corresponding cation is a chemically or pharmaceutically acceptable one.

According to a peculiar advantage of the process occurring through steps (i)-(vi′) above, the present invention allows the preparation of depolymerized-LMW-epiK5-N,O-sulfates having a mean molecular weight lower than 5,000, preferably lower than 4,000, in particular from about 1,500 to about 5,000, preferably from about 1,500 to about 4,000 and presenting the unit (a′) as defined above at the reducing end of the majority of their chains.

Thus, the present invention also provides depolymerized-LMW-epiK5-N,O-sulfates of this type, consisting of mixtures of chains in which the preponderant species is a compound of formula IV wherein q is 8 or 9, R° is 45%-55% SO₃⁻, R′ is 35%-45% SO₃⁻ in glucuronic acid, R″ is 15%-25% SO₃⁻ in iduronic acid, for a sulfation degree of from 2.7 to 2.9, and presents a sulfated 2,5-anidromannitol unit of structure (a′) as defined above at the reducing end of the majority of their chains, and chemically or pharmaceutically acceptable salts thereof.

The new depolymerized-LMW-epiK5-N,O-sulfates of the present invention possess a very interesting activity on the coagulation parameters. In fact, they have high anti-Xa and anti-IIa activities and involve a very low risk of inducing bleeding in patients in need of a heparinic treatment for the control of the coagulation. Depolymerized-LMWepiK5-N,O-sulfates having a mean molecular weight of about 6,000,95-100% N-sulfated, 80-95% 6-O-sulfated on glucosamine, 45-55% 3-O-sulfated on glucosamine, 35-45% 3-O-sulfated on glucuronic acid, 15-25% 2-O-sulfated on iduronic acid, for a sulfation degree of from 2.7 to 2.9, presenting an unity (a′) at the reducing end of the majority of its chains, and their pharmaceutically acceptable salts, are particularly interesting. One of these depolymerized-LMW-epiK5-N,O-sulfates, illustrated hereinbelow in Example 18, has been tested in the classical assays of the anti-Xa and anti-IIa activities, and its effect on the Activated Partial Thromboplastin Time (APTT) has also been tested.

Activity assays used for the determination of the anti-Xa and anti-Xa activities are based on the inhibition of coagulation enzymes by the complex formed by heparin and antithrombin III (ATIII). ATIII and factor IIa or factor Xa are added in excess. Residual clotting enzyme reacts with a substrate resulting in a release of spectrophotometrically measurable paranitroaniline, which level is inversely proportional to the level of the clotting enzyme. The used buffers are: 0.9% NaCl in the determination of the anti-Xa activity and Tris 0.05M+NaCl 0.15 M and 1% BSA (Bovine Serum Albumine) in the determination of the anti-IIa activity. The activity of the depolymerized-LMW-epiK5-N,O-sulfate and of the reference compounds (a commercial, unfractionated heparin and a commercial LMWH) were measured against International LMWH standard in terms of anti-Xa and anti-IIa activities. Dilution indicating activity approximately 0.5 U/ml in terms of anti-Xa activity and 0.05 U/ml for anti-IIa activity were determined. A specific activity for unfractionated heparin of 160 U/ml was assumed for calculations.

The effect of the depolymerized-LMW-epiK5-N,O-sulfate of the invention and of the reference products on APTT was measured using IL Test™ APTT Lyophilized Silica Kit. Coagulation is initiated in citrated plasma by adding phospholipids which are required to form complexes which activate Factor X and prothrombin. A contact activator is used to stimulate the production of Factor XIIa by providing a surface for the function of high molecular weight kininogen, kallikrein and Factot XIIa. Calcium is added to trigger further reactions. Time required for clot formation is measured.

In the comparison of the effect of the test and reference compounds on coagulation time, an estimate dose causing coagulation of 100 sec was used. To get this value a dose response curve was prepared using doses causing coagulation times in the range of 50 and 230 seconds. Dose causing a coagulation time of 100 sec was obtained as an estimate from a trend line.

From the aforesaid tests, it resulted that the anti-Xa and anti-IIa activities of the depolymerized-LMW-epiK5-N,O-sulfate of the invention are about 50% of that of LMWH. As a consequence, the depolymerized-LMW-epiK5-N,O-sulfate of the invention, as antithrombotic agent, may be considered as a LMWH with an anti-Xa and anti-IIa activities of the same order of magnitude.

In addition, it resulted that the potency of the depolymerized-LMW-epiK5-N,O-sulfate of the invention in increasing coagulation is weak. In comparison with unfractionated heparin and LMWH, approximately 5-8 fold doses of depolymerized-LMW-epiK5-N,O-sulfate were needed to induce the same effect on APTT.

Thus, the present invention provides, for the first time, a product derived from the polysaccharide K5 that has the same biological characteristics as the LMWH, but with a lower hemorrhagic risk. The new depolymerized-LMW-epiK5-N,O-sulfates of the present invention, and their pharmaceutically acceptable salts, are thus useful as medicaments for the control of coagulation and for the prevention or the treatment of thrombosis as well as active ingredients of pharmaceutical compositions for the above mentioned indications.

Due to their characteristics, the glycosaminoglycans of the present invention may be used alone or in combination with acceptable pharmaceutical excipients or diluents, for the control of the coagulation and for the antithrombotic treatment, in particular for the prevention or for the treatment of thrombosis.

Therefore, it is a further object of the present invention to provide pharmaceutical compositions comprising, as an active ingredient, a pharmacologically active amount of a C5-epimerized N,O-sulfate K5 glycosaminoglycan obtainable according to the process wherein steps (i)-(vi) above, including the optional depolymerization and formation of a pharmaceutically acceptable salt are performed as illustrated above, in admixture with pharmaceutically acceptable excipients or diluents.

Preferably, the active ingredient is obtainable according to steps (i)-(vi) above, including pharmaceutically acceptable salt formation, starting from a previously purified K5 and carrying out step (iv) in dimethyl sulfoxide/methanol 9/1 (V/V) at about 60° C. for about 150 minutes, and submitting the C5-epimerized N,O-sulfate K5 obtained at the end of step (vi) to depolymerization. Preferably, the thus obtainable C5-epimerized N,O-sulfate K5 glycosaminoglycan active ingredient is in form of an alkaline metal, alkaline-earth metal, aluminium or zinc salt

Particularly, the present invention provides pharmaceutical compositions comprising a pharmacologically effective amount of a glycosaminoglycan constituted by a mixture of chains in which at least 90% of said chains has the formula I above, wherein 40-60% of the uronic acid units are those of iduronic acid, n is an integer of from 3 to 100, R, R₁, R₂ and R₃ represent a hydrogen atom or a SO₃⁻ group and from about 65% to about 50% of R, R₁, R₂ and R₃ being hydrogen and the remaining being SO₃⁻ groups distributed as follows
R₃ is from about 85% to about 95% SO₃⁻;
R₂ is from about 17% and about 21% SO₃⁻;
R₁ is from about 15 to about 35% SO₃⁻ in iduronic units and 0 to 5% SO₃⁻ in glucuronic units;
R is from about 20 to about 40% SO₃⁻ in glucuronic units and 0 to 5% in iduronic units;
the sum of the SO₃⁻ percent in R1, glucuronic units, and in R, iduronic units, is from 3 to 7%;
   R₁ and R being not simultaneously SO₃⁻ and being both hydrogen in 25-45% of the uronic acid units; the sulfation degree being from about 2.3 to about 2.9, and the corresponding cation being a pharmaceutically acceptable one, as an active ingredient, and a pharmaceutical carrier.

More particularly the above compositions are indicated for the control of the coagulation or for the prevention or treatment of thrombosis.

In said pharmaceutical compositions, for intravenous, subcutaneous or topical use, said glycosaminoglycan active ingredient is present in an effective dose for the prevention or treatment of diseases caused by disorders of the coagulation system, such as arterial or venous thrombosis, for the treatment of haematomas or as coagulation controlling agents during surgical operations.

In preparations for intravenous or subcutaneous use, the glycosaminoglycan active ingredient is dissolved in water, if necessary in the presence of a buffer and the solution is introduced in vials or syringes under sterile conditions.

Unit doses of said pharmaceutical compositions contain from 5 to 100 mg advantageously from 20 to 50 mg of active ingredient dissolved in 0.1 to 2 ml of water.

In compositions for topical use, the glycosaminoglycan active ingredient is mixed with pharmaceutically acceptable carriers or diluents known in the art for the preparation of gels, creams, ointments, lotions or solutions to be sprayed. In said compositions, the glycosaminoglycan active ingredient is present in a concentration of from 0.01% to 15% by weight advantageously.

Advantageous pharmaceutical compositions comprise, as an active ingredient, a pharmacologically active amount of a glycosaminoglycan constituted by a mixture of chains of formula I, as illustrated above, in which the counter-ion is a pharmaceutically acceptable one, advantageously a cation selected from the group consisting of alkaline metal, alkaline-earth metal, aluminium and zinc ions, preferably the sodium or calcium ion, and a pharmaceutical carrier.

Among these advantageous glycosaminoglycans, those which contain at least 80% of chains of formula I wherein n is from 3 to 15 or from 20 to 100 are preferred active ingredients, those in which the mixture of chains has a molecular weight distribution ranging from about 2,000 to about 10,000, with a mean molecular weight of from about 4,000 to about 8,000 or a molecular weight distribution ranging from about 9,000 to about 60,000, with a mean molecular weight of from about 12,000 to about 30,000, being particularly preferred.

Particularly advantageous pharmaceutical compositions comprise, as an active ingredient, a glycosaminoglycan constituted by a mixture of depolymerized chains in which at least 90% of said chains have the formula I above, wherein 40-60% of the uronic acid units are those of iduronic acid, n is an integer of from 3 to 100, R, R₁, R₂ and R₃ represent a hydrogen atom or a SO₃⁻ group, from about 65% to about 50% of R, R₁, R₂ and R₃ being hydrogen and the remaining being SO₃⁻ groups distributed as follows
R₃ is from about 85% to about 95%, preferably about 85%, SO₃⁻;
R₂ is from about 17 to about 21%, preferably about 20%, SO₃⁻;
R₁ is from about 15 to about 35%, preferably about 25%, SO₃⁻ in iduronic units and 0 to about 5% SO₃⁻ in glucuronic units;
R is from about 20 to about 40% SO₃⁻ in glucuronic units and 0 to about 5% in iduronic units;
the sum of the SO₃⁻ percent in R₁, glucuronic units, and in R, iduronic units, is from about 3 to about 7%;
   R₁ and R being not simultaneously SO₃⁻ and being both hydrogen in 25-45% of the uronic acid units; the sulfation degree being from about 2.3 to about 2.9, preferably from about 2.4 to about 2.7, and the corresponding cation being a pharmaceutically acceptable one, said mixture of depolymerized chains containing at least 80% of said chains with a molecular weight distribution in the range of from about 2,000 to about 10,000 and a mean molecular weight of from about 4,000 to about 8,000.

Advantageous pharmaceutical compositions comprise, as an active ingredient, a pharmacologically active amount of a glycosaminoglycan constituted by a mixture of chains with a mean molecular weight of from about 6,000 to about 8,000, in which at least 90% of said chains have the formula I above, wherein about 55% of the uronic acid units are those of iduronic acid and R₃ is from about 85% to about 90% SO₃⁻; R₂ is about 20% SO₃⁻; R₁ is from about 25% to about 30% SO₃⁻ in iduronic units and 0 to about 5% SO₃⁻ in glucuronic units; R is from about 30% to about 35% SO₃⁻ in glucuronic units and 0 to about 5% in iduronic units; the sum of the SO₃⁻ percent in R₁, glucuronic units and in R, iduronic units, is about 5%; R₁ and R being not simultaneously SO₃⁻ and being both hydrogen in from about 30% to about 40% of the uronic acid units; the sulfation degree being from about 2.5 to about 2.7, the corresponding cation being a chemically or pharmaceutically acceptable one.

A preferred low molecular weight glycosaminoglycan active ingredient of this class is constituted by a mixture of chains with a mean molecular weight of about 7,000, in which at least 90% of said chains have the formula I above, wherein about 55% of the uronic acid units are those of iduronic acid and
R₃ is about 85% SO₃⁻;
R₂ is about 20% SO₃⁻;
R₁ is about 25% SO₃⁻ in iduronic units and 0 to about 5% SO₃⁻ in glucuronic units;
R is about 30% SO₃⁻ in glucuronic units and 0 to about 5% in iduronic units;
the sum of the SO₃⁻ percent in R₁, glucuronic units, and in R, iduronic units, is about 5%;
   R₁ and R being not simultaneously SO₃⁻ and being both hydrogen in about 40% of the uronic acid units; the sulfation degree being about 2.55, the corresponding cation being a pharmaceutically acceptable one. A particular preferred glycosaminoglycan active ingredient has these characteristics, with a mean molecular weight of 7,400.

Particularly advantageous pharmaceutical compositions are those comprising, as an active ingredient, a pharmacologically active amount of a depolymerized-LMW-epiK5-N,O-sulfate as illustrated above, in particular a depolymerized-LMW-epiK5-N,O-sulfate having a sulfation degree of from 2.3 to 2.9, a mean molecular weight of from about 1,500 to about 12,000 and presenting the structure (a′), as defined above, at the reducing end of the majority of its chains, or of a pharmaceutically acceptable salt thereof, in admixture with a pharmaceutical carrier.

In the pharmaceutical compositions of the present invention for oral, subcutaneous, intravenous, transdermic, ophthalmic or topical administration, the active ingredients are preferably administered as dosage units, in admixture with the classic pharmaceutical carriers or vehicles.

The dose can amply change in function of age, weight, and health conditions of the patient. This dose comprises the administration of a dosage unit of from 1 to 1,000 mg, advantageously from 10 to 750 mg, preferably from 250 to 500 mg, once to three times per day, by intravenous, subcutaneous, oral, transdermic, ophthalmic or topical route. By parenteral (subcutaneous or intravenous) administration the preferred dose is of from 5 to 100 mg.

Advantageously, the pharmaceutical compositions of the present invention comprise, as an active ingredient thereof, a depolymerized-LMW-epiK5-N,O-sulfate obtainable starting from a K5-N-sulfate, according to the steps (i)→(ii)→(ii′)→(iv) as illustrated above process, or a pharmaceutically acceptable salt thereof. More advantageously, said active ingredient is a depolymerized-LMW-epiK5-N,O-sulfate having a sulfation degree of from 2.3 to 2.9, a mean molecular weight of from about 1,500 to about 12,000 and presents the structure (a′) as defined above at the reducing end of the majority of its chains. The depolymerized-LMW-epiK5-N,O-sulfates consisting of mixtures of chains in which at least 80% of said chains has the formula IV above and present the structure (a′) at the reducing end of the majority of said chains are particularly interesting active ingredients. Preferably, said depolymerized-LMW-epiK5-N,O-sulfate active ingredient has a mean molecular weight of about 6,000, is 95%-100% N-sulfated, 80%-95% 6-O-sulfated on glucosamine, 45%-55% 3-O-sulfated on glucosamine, 35%-45% 3-O-sulfated on glucuronic acid, 15%-25% 2-O-sulfated on iduronic acid, for a sulfation degree of from 2.7 to 2.9.

Finally the present invention refers to the effective amount of said glycosaminoglycans for the control of the coagulation and for an antithrombotic treatment.

Thus, it is a further object of the present invention to provide a method for controlling coagulation in a mammal, or for the prevention or treatment of thrombosis, which comprises administering to said mammal, in need of said coagulation control or in need of said prevention or treatment, a pharmacologically effective amount of a C5-epimerized N,O-sulfate K5 glycosaminoglycan obtainable according to the process wherein steps (i)-(vi) above, including the optional depolymerization and pharmaceutically acceptable salt formation, are performed.

More particularly, said method comprises administering to said mammal a pharmacologically active amount of a glycosaminoglycan constituted by a mixture of chains in which at least 90% of said chains have the formula I as illustrated and specified above.

Preferably, the method of the present invention comprises administering to said mammal a pharmacologically active dose of a pharmaceutical composition as illustrated above.

According to another of its aspects, the present invention provides a method for the control of the coagulation in a mammal, which comprises administering to said mammal in need of said control of the coagulation an effective amount of a depolymerized-LMW-epiK5-N,O-sulfate obtainable by the process comprising steps (i)-(vi′) as illustrated above. Moreover, the invention provides a method for preventing or treating thrombosis in a mammal, which comprises administering to said mammal an effective amount of a depolymerized-LMW-epiK5-N,O-sulfate as illustrated above. For the control of the coagulation or for preventing or treating thrombosis, the effective amount of depolymerized-LMW-epiK5-N,O-sulfate is of from 5 to 100 mg. Said effective amount is administered in a pharmaceutical composition among those illustrated above. Advantageously, said depolymerized-LMW-epiK5-N,O-sulfate has a sulfation degree of from 2.3 to 2.9, a mean molecular weight of from about 1,500 to about 12,000 and presents the structure (a′) as defined above at the reducing end of the majority of its chains.

The depolymerized-LMW-epiK5-N,O-sulfates consisting of mixtures of chains in which at least 80% of said chains has the formula IV above and present the structure (a′) at the reducing extremity of the majority of said chains are particularly useful. A preferred depolymerized-LMW-epiK5-N,O-sulfate has a mean molecular weight of about 6,000, is 95%-100% N-sulfated, 80%-95% 6-O-sulfated on glucosamine, 45%-55% 3-O-sulfated on glucosamine, 35%-45% 3-O-sulfated on glucuronic acid, 15%-25% 2-O-sulfated on iduronic acid, for a sulfation degree of from 2.7 to 2.9.

The following examples illustrate the invention without, however, limiting it.

### Preparation of Depolymerized-LMW-epiK5-N-Sulfates

Preparation I

(i) K5-N-sulfate

K5-N-sulfate is prepared as described in Example 1, steps (i) and (ii), of WO 02/068477. Its ¹H-RMN spectrum shows no signals relating to acetyl groups or NH₂.

(ii) epiK5-N-sulfate

Ten grams of K5-N-sulfate obtained in step (i) are dissolved in 600 ml of 25 mM HEPES buffer at pH 7, containing CaCl₂ at a concentration of 50 mM and the solution thus obtained is made to recirculate through a 50 ml column filled with Sepharose 4B resin containing 50 mg of recombinant C5-epimerase (WO 96/14425) immobilized as described in Example 1. The reaction is carried out at 30° C. at pH 7 with a flow of 200 ml/h for 24 hours. The product obtained is purified by ultrafiltration and precipitation with ethanol. Thus, an epiK5-N-sulfate having an iduronic acid content of 54% is obtained.

(ii′) Depolymerized-LMW-epiK5-N-sulfate.

To a solution of 1 g of the product thus obtained, in 25 ml of distilled water, 230 mg of sodium nitrite dissolved in 115 ml of distilled water are added. The solution is then brought to 4° C., the pH is adjusted to 2 with 0.1 N HCl and maintained for 30 minutes. At the end of the reaction the solution is brought to room temperature and the pH to 7 with 0.1 N NaOH. The solution is then added with 450 mg of NaBH₄ and left to react for 4 hours. The product is recovered by precipitation with 3 volumes of acetone at 4° C., filtration with filtering funnel and dried at 40° C. in a vacuum oven to give 900 mg of depolymerized-LMW-epiK5-N-sulfate with an iduronic acid content of 54% and a molecular weight distribution from 1,000 to 4,000, measured with HPLC method.

Preparation II

(i) K5-N-sulfate

K5-N-sulfate is prepared as described in Example 1, steps (i) and (ii), of WO 02/068477. Its ¹H-RMN spectrum shows no signals relating to acetyl groups or NH₂.

(ii) epiK5-N-sulfate

A 2 g amount of the K5-N-sulfate obtained in step (i) is dissolved in 120 ml of 25 mM HEPES buffer, pH 7, containing 50 mM CaCl₂. The solution obtained is made to recirculate through a 50 ml column filled with the resin containing the immobilized enzyme obtained as described in WO 96/14425. This operation is carried out at 30° C. with a flow of 200 ml/h for 24 hours. The product obtained is purified by ultrafiltration through a 1000 D membrane, by passing the solution over an IR 120H⁺ ionic exchange column and neutralizing the eluate with 1N NaOH. The sample is recovered by precipitation with ethanol or acetone. An epimerized product is obtained with an iduronic acid/glucuronic acid ratio of 55/45 against a ratio of 0/100 of the starting product. The percentage of epimerization was calculated with ¹H-NMR according to the method described in WO 96/14425. The yield in epiK5-N-sulfate, calculated by measuring the content of uronic acids against a standard with the carbazole method (Bitter and Muir Anal. Biochem. 39, 88-92-1971) is 90%.

(ii) Depolymerized-LMW-epiK5-N-sulfate.

One gram of product obtained in step (ii) is dissolved in 25 ml of distilled water and 230 mg of sodium nitrite dissolved in 115 ml of distilled water are added to the mixture. The obtained solution is then brought to 4° C. and the pH to 2 with 0.1 N HCl and maintained for 30 minutes. At the end of the reaction the solution is brought to room temperature and the pH to 7 with 0.1 M NaOH. The solution is then added with 450 mg. of NaBH₄ and left to react for 4 hours. The product is recovered by precipitation with 3 volumes of acetone at 4° C., filtration with filtering funnel and dried at 40° C. in a vacuum oven to give 900 mg of depolymerized-LMW-epiK5-N-sulfate with a molecular weight distribution measured by HPLC method which ranges from 1,000 to 4,000 and with a glucuronic unit content of 45% and an iduronic unit content of 55%.

Preparation III

Depolymerized-LMW-epiK5-N-sulfate Having a Mean Molecular Weight of About 2,000

To a solution of 1 g of the epiK5-N-sulfate obtained in step (ii) of Example 12 below in 200 ml of distilled water, 480 mg of sodium nitrite dissolved in 240 ml of distilled water are added. The solution is then brought to 4° C., the pH is adjusted to 2 with 0.1 N HCl and maintained for 30 minutes. At the end of the reaction the solution is brought to pH 7 with 0.1 M NaOH and then to room temperature. The solution is then added with 450 mg. of NaBH₄ and reacted for 4 hours. The excess NaBH₄ is eliminated by adjusting the pH to 5-6 with HCl. The product, neutralized with 0.1 M NaOH, is recovered by precipitation with 3 volumes of acetone at 4° C., filtration with filtering funnel and dried at 40° C. in a vacuum oven. 900 mg of depolymerized-LMW-epiK5-N-sulfate are obtained with a mean molecular weight of approximately 2,000, consisting of a mixture of chains in which the preponderant species is a compound of formula II′b in which m is 4.

### EXAMPLE 1

Example 1 is performed according to the following steps:

(a) 10 g of polysaccharide obtained by fermentation as described in the Italian patent application M199A001465 (WO 01/02597) with a purity of 80% (FIG. 2) are dissolved in deionized water to obtain a 1% solution. Triton X-100 is added to reach a concentration of 5% and the solution is kept at 55° C. for 2 hours under stirring. The solution is brought to 75° C. and kept at this temperature till a homogeneous turbid system is obtained and then the solution is rapidly cooled to room temperature. During the cooling two phases are formed. Said thermic treatment is repeated twice on the upper phase (organic phase). The aqueous phase containing K5 is finally 1/10 concentrated under reduced pressure and precipitated with acetone or ethanol. The organic phase is discarded.

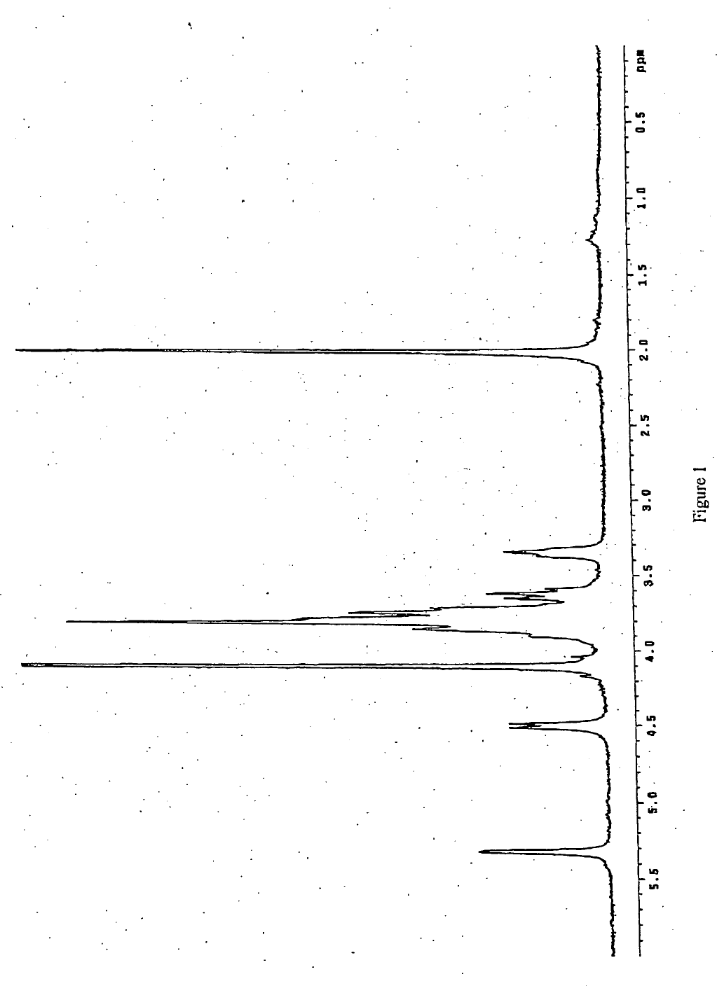

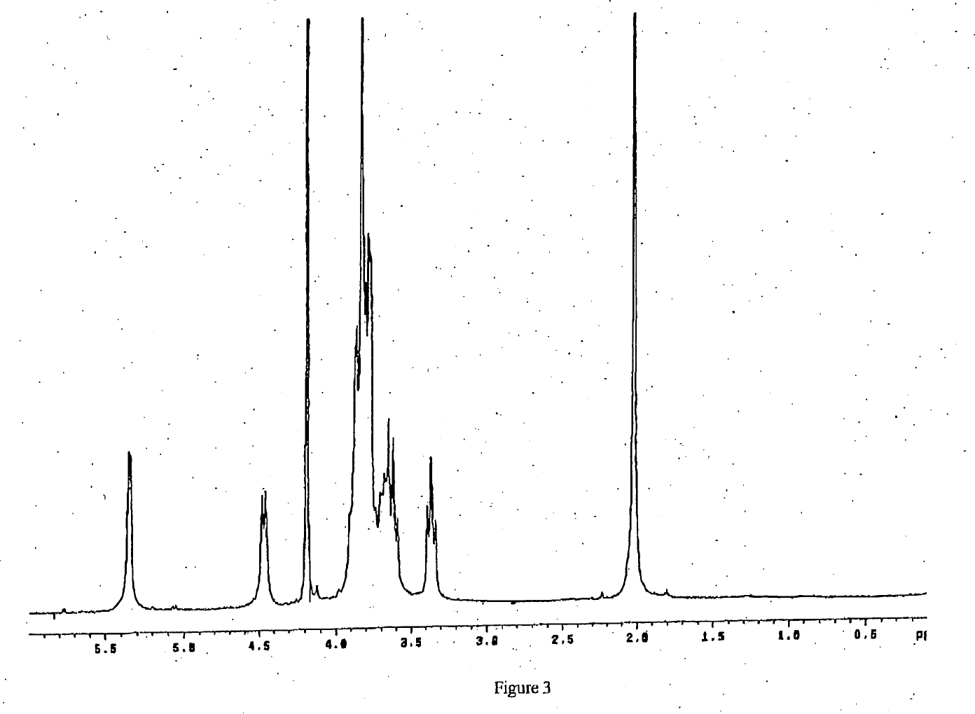

The product obtained is K5 polysaccharide with 90% purity detected by proton NMR (FIG. 3) compared to the spectrum of the working standard (FIG. 1).

(b) The product obtained in step (a) is dissolved in 1,000 ml of 2 N sodium hydroxide and kept at 60° C. for 18 hours. The solution is cooled to room temperature and then brought to neutral pH with 6N hydrochloric acid. N-deacetylated K5 (K5-amine) is obtained.

The solution containing the K5-amine is kept at 40° C. and added with 10 g sodium carbonate in one step and 10 g of adduct pyridine.SO₃ in 10 minutes. At the end of the reaction the solution is cooled to room temperature and then brought to pH 7.5-8 with a 5% hydrochloric acid solution.

The product obtained, K5-N-sulfate, is purified from salts by diafiltration using a 1,000 D cut off spirale membrane (prepscale cartridge—Millipore). The purification process is stopped when the conductivity of the permeate is less than 100 μS. The product retained by the membrane is concentrated to 10% polysaccharide using the same diafiltration system and then is freeze dried.

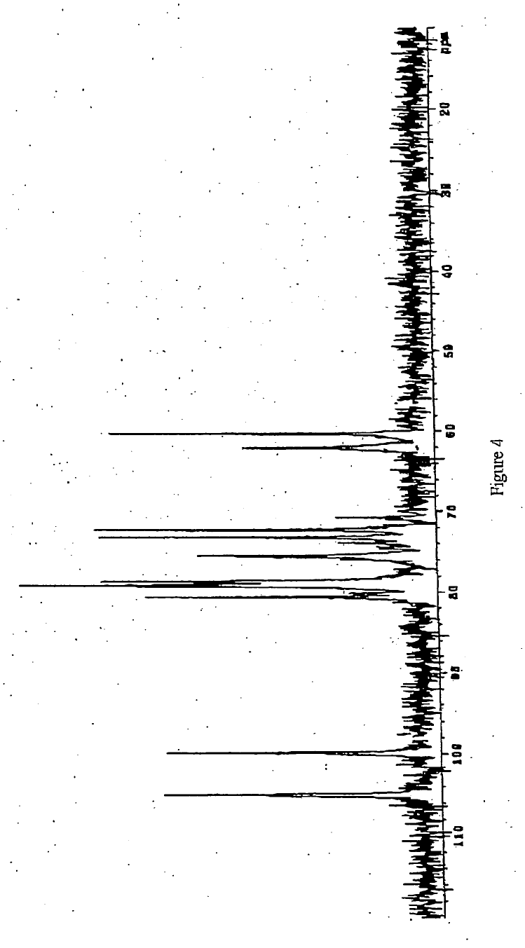

The ratio N-sulfate/N-acetyl in the product obtained is 9.5/0.5 measured by carbon 13 NMR (FIG. 4).

(c) 1—Preparation of the Immobilized C5 Epimerase.

To 5 mg of recombinant C5 epimerase obtained according to WO98/48006 corresponding to 1.2×10¹¹ cpm (counts per minutes) dissolved in 200 ml of 25 mM Hepes buffer pH 7.4, containing 0.1 M KCl, 0.1% Triton X-100 and 15 mM EDTA, 100 mg of K5-N-sulfate obtained as described in step (b) are added. The solution is diafiltrated with a 30,000 D membrane at 4° C. till disappearance of K5-N-sulfate in the permeate. To the solution rententated by the membrane the buffer is changed by diafiltration against 200 mM NaHCO₃ at pH 7 and, after concentration to 50 ml, 50 ml of CNBr activated Sepharose 4B resin are added and kept to react overnight at 4° C. At the end of the reaction the amount of residual enzyme in the supernatant is measured with the Quantigold method (Diversified Biotec) after centrifugation. The enzyme in the supernatant is absent, showing that with the method described the enzyme is 100% immobilized. To occupy the sites still available, the resin is washed with 100 mM tris pH 8. To measure the activity of the immobilized enzyme an amount of immobilized enzyme theoretically corresponding to 1.2×10⁷ cpm is loaded into a column. In the column obtained 1 mg of K5-N-sulfate obtained as described in step (b) dissolved in 25 mM Hepes, 0.1M KCl, 0.015 M EDTA, 0.01% Triton X-100, pH 7.4 buffer is dissolved, recirculating it through said column at 37° C. overnight at a flow rate of 0.5 ml/minute. After purification by DEAE chromatographic system and desalting on a Sephadex G-10 the sample is freeze dried and analyzed for its content in iduronic acid by proton NMR as described in WO 96/14425.

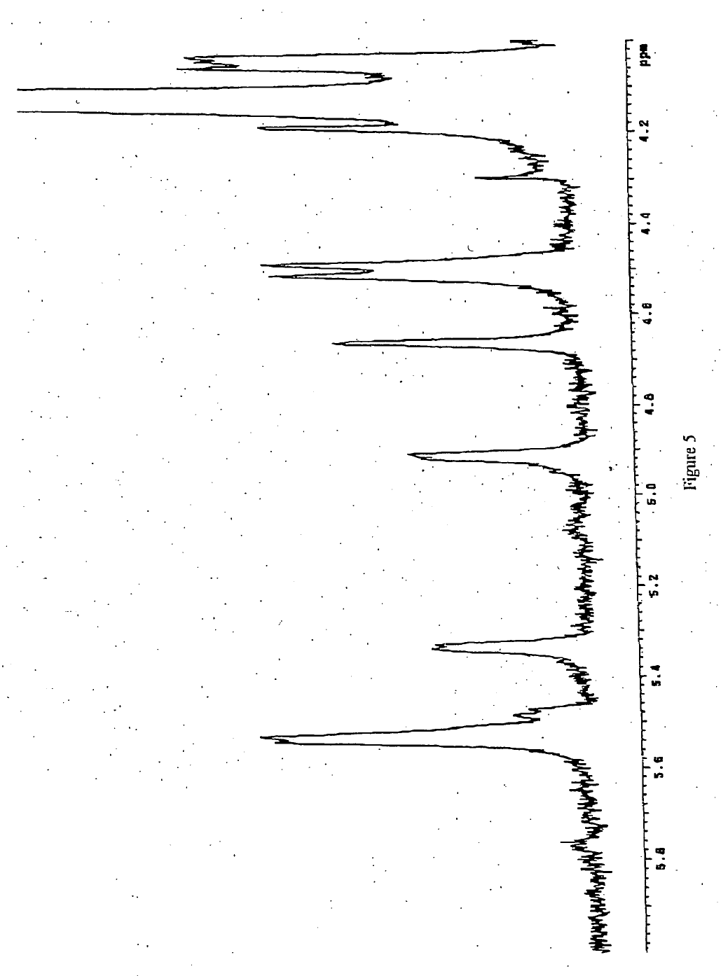

The ratio iduronic acid/glucuronic acid is 30/70 (FIG. 5).

2—Epimerization.

An amount of 10 g of K5-N-sulfate is dissolved in 600 ml of 25 mM Hepes buffer pH 6.5 containing 50 mM CaCl₂. The solution obtained is recirculated through a column of 50 ml containing the resin with the immobilized enzyme. This reaction is performed at 37° C. with a flow rate of 200 ml/hour for 24 hours. The product obtained is purified by ultrafiltration and precipitation with ethanol. The pellet is dissolved in water at 10% concentration.

An epimerized product is obtained with an iduronic acid/glucuronic acid ratio of 48/52 against a ratio 0/100 of the starting material.

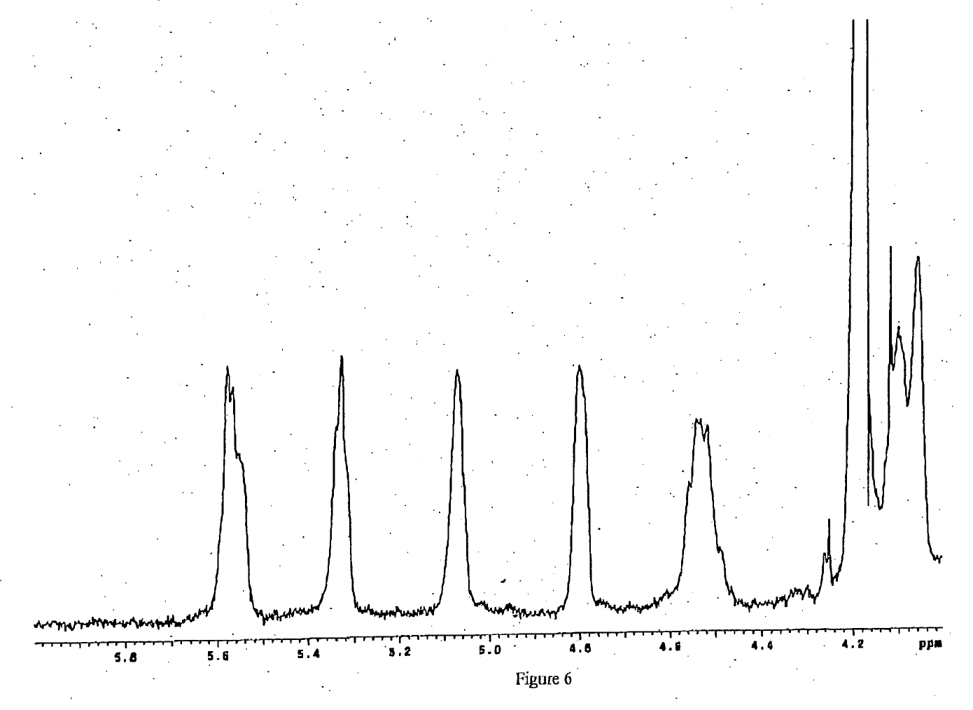

The percentage of epimerization is calculated by ¹H-NMR (FIG. 6).

The yield calculated measuring the uronic acid content against standard by the carbazole method (Bitter and Muir Anal. Biochem. 39 88-92 (1971)) is 90%.

(d) The solution containing the epimerized product with 10% concentration obtained in step (c) is cooled to 10° C. with a cooling bath and then applied onto a IR 120H⁺ cationic exchange resin (50 ml). Both the column and the container of the eluted solution are kept at 10° C. After the passage of the solution the resin is washed with 3 volumes of deionized water. The pH of the flow through is more than 6. The acidic solution is brought to neutrality with an aqueous solution of 15% tetrabutylammoniun hydroxide. The solution is concentrated to 1/10 of the volume in a rotating evaporator under vacuum and freeze dried. The product is suspended in 200 ml of DMF and added with 150 g of the adduct pyridine.SO₃ dissolved in 200 ml of DMF. The solution is kept at 45° C. for 18 hours. At the end of the reaction the solution is cooled to room temperature and added with 1,200 ml of acetone saturated with sodium chloride. The pellet obtained is separated from the solvent by filtration, dissolved with 100 ml of deionized water and sodium chloride is added to 0.2 M concentration. The solution is brought to pH 7.5-8 with 2N sodium hydroxide and 300 ml of acetone are added. The pellet is separated by filtration. The solid obtained is solubilized with 100 ml deionized water and purified from the residual salts by diafiltration as described in step (b).

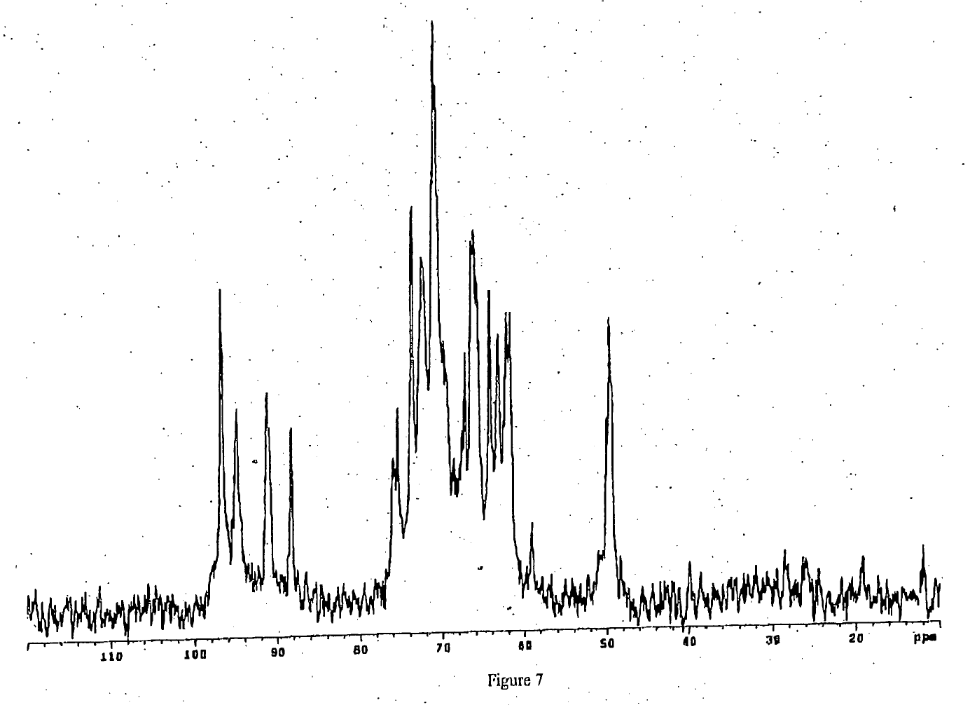

The ¹³C-NMR analysis on a dried small amount of the oversulfated product is shown in FIG. 7.

(e) The solution containing the product of step (d) is passed onto a IR 120H⁺ cationic exchange resin (50 ml). After the passage of the solution the resin is washed with 3 volumes of deionized water. The pH of the flow through is more than 6. The acidic solution is brought to neutrality with pyridine. The solution is concentrated to 1/10 of the volume in a rotating evaporator at 40° C. under vacuum and freeze dried. The product obtained as pyridine salt is added with 500 ml of a solution of DMSO/methanol (9/1 V/V). The solution is kept at 60° C. for 3.5 hours and then added with 50 ml deionized water and finally treated with 1,650 ml acetone saturated with sodium chloride. The solid obtained is purified by diafiltration as described in step (b) and a solution at 10% concentration is obtained.

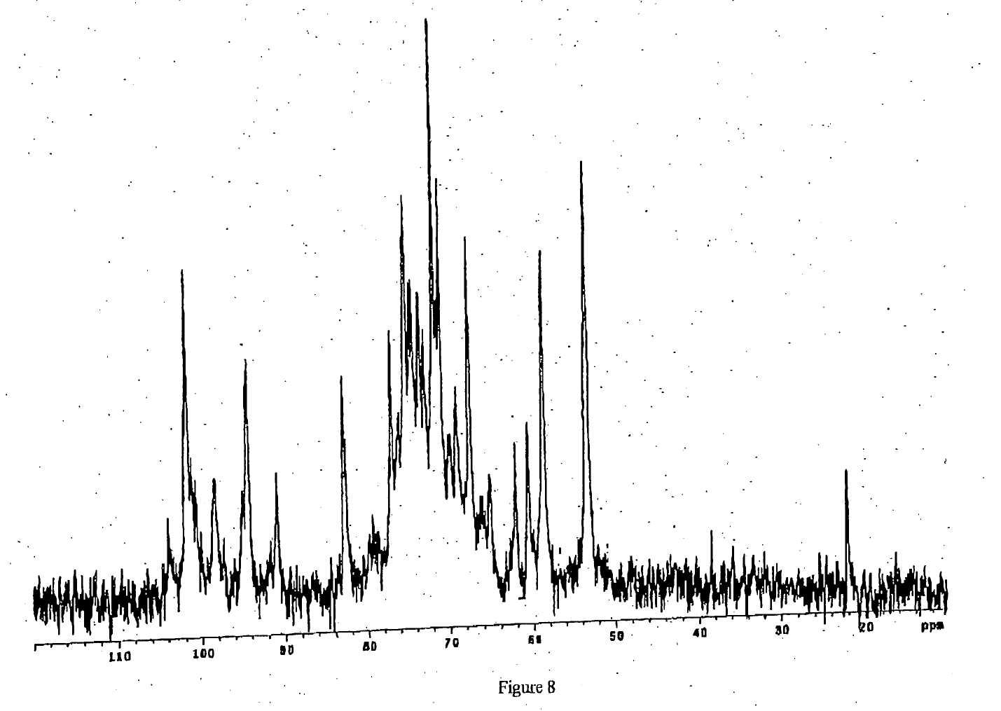

The ¹³C-NMR analysis on a dried small amount in FIG. 8 shows a content of sulfate groups in position 6 of the amino sugar of 35%.

(f) The solution containing the product of step (e) is passed onto a IR 120H⁺ cationic exchange resin (50 ml). After the passage of the solution the resin is washed with 3 volumes of deionized water. The pH of the flow through is more than 6. The acidic solution is brought to neutrality with an aqueous solution of 15% tetrabutylammoniun hydroxide. The solution is concentrated to 1/10 of the volume in a rotating evaporator under vacuum and freeze dried. The product as tetrabutylammonium salt is suspended in 200 ml DMF. The suspension is cooled to 0° C. and treated with 40 g of the adduct pyridine.SO₃ dissolved in 100 ml DMF. The sulfating agent is added one step. The solution is kept at 0° C. for 1.5 hours and then is treated with 750 ml acetone saturated with sodium chloride.

The solid obtained is purified by diafiltration as described in step (b).

(g) The solution of step (f) is treated as described in step (b) for N-sulfation.

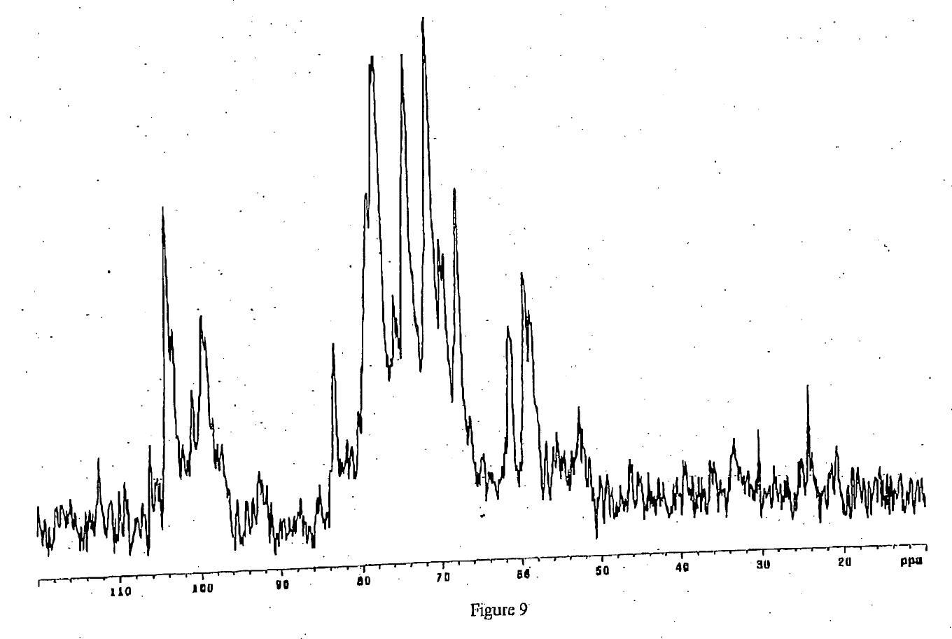

The ¹³C-NMR on a dried small amount of the product obtained is shown in FIG. 9.

The product obtained shows the physico-chemical and biological characteristics of table 2-line 3 compared with the 4th International Standard Heparin and the 1st International Standard Low Molecular Weight Heparin.

### EXAMPLE 2

Example 1 was repeated but in step (c) the immobilized enzyme C5-epimerase extracted from murine mastocytoma was used as described by Jacobsson et al. J. Biol. Chem. 254 2975-2982 (1979), in a buffer containing 40 mM CaCl₂ pH 7.4.

The product obtained has a ratio iduronic acid/glucuronic acid of 59.5:40.5 and the characteristics described in table 2, line 4.

### EXAMPLE 3

Example 1 was repeated but in step (c) the immobilized enzyme C5-epimerase extracted from bovine liver was used as described in WO96/14425 with a reaction buffer at pH 7.4 and reaction time of 32 hours. Moreover in step (e) the reaction time was 4 hours.

The product obtained has a ratio iduronic acid/glucuronic acid of 55.4:44.6 and the characteristics described in table 2, line 5.

### EXAMPLE 4

Example 1 was repeated but in step (c) the recombinant enzyme C5-epimerase in solution was used using for the epimerization 10 g K5-N-sulfate dissolved in 1,000 ml of 25 mM Hepes buffer pH 6.5 containing 50 mM CaCl₂. To this solution 1.5×10¹¹ cpm equivalents of recombinant enzyme described in example 1 are added. The solution is kept at 37° C. for 24 hours. The solution is then treated at 100° C. for 10 minutes to denaturate the enzyme and finally is filtered on a 0.45μ filter to obtain a clear solution containing the product. The product obtained is then purified by diafiltration and precipitation with ethanol or acetone. The pellet is dissolved in water at 10% concentration and treated like in example 1 keeping the reaction time of step (e) for 2 hours.

The product obtained has a ratio iduronic acid/glucuronic acid of 56/44 and the characteristics described in table 2, line 6.

### EXAMPLE 5

Example 4 is repeated using in step (c) the enzyme from murine mastocytoma described in example 2, in solution, with the reaction buffer at pH 7.4 containing 40 mM BaCl₂ and performing the reaction for 18 hours. Moreover in step (e) the reaction time is 3 hours.

The product obtained has a ratio iduronic acid/glucuronic acid of 40.1:59.9 and the characteristics described in table 2, line 7.

### EXAMPLE 6

Example 4 is repeated using in step (c) the enzyme from bovine liver of example 3, in solution, with the reaction buffer containing 12.5 mM MnCl₂ and performing the reaction for 14 hours. Moreover in step (e) the reaction time is 4 hours.

The product obtained has a ratio iduronic acid/glucuronic acid of 44.3/55.7 and the characteristics described in table 2, line 8.

### EXAMPLE 7

Example 4 is repeated using in step (c) a reaction buffer at pH 7.4 containing 37.5 mM MgCl₂ and performing the reaction for 16 hours. Moreover in step (e) the reaction time is 4 hours.

The product obtained has a ratio iduronic acid/glucuronic acid of 47.5/52.5 and the characteristics described in table 2, line 9.

### EXAMPLE 8

Example 3 is repeated using in step (c) a reaction buffer at pH 7.0 containing 10 mM MgCl₂, 5 mM CaCl₂, 10 mM MnCl₂ and performing the reaction for 24 hours. Moreover in step (e) the reaction time is 3 hours.

The product obtained has a ratio iduronic acid/glucuronic acid of 44.8/55.2 and the characteristics described in table 2, line 10.

### EXAMPLE 9

Example 6 is repeated using in step (c) a reaction buffer at pH 7.4 containing 10 mM MgCl₂, 5 mM CaCl₂, 10 mM MnCl₂ and performing the reaction for 24 hours. Moreover in step (e) the reaction time is 3 hours.

The product obtained has a ratio iduronic acid/glucuronic acid of 52/48 and the characteristics described in table 2, line 11.

### EXAMPLE 10

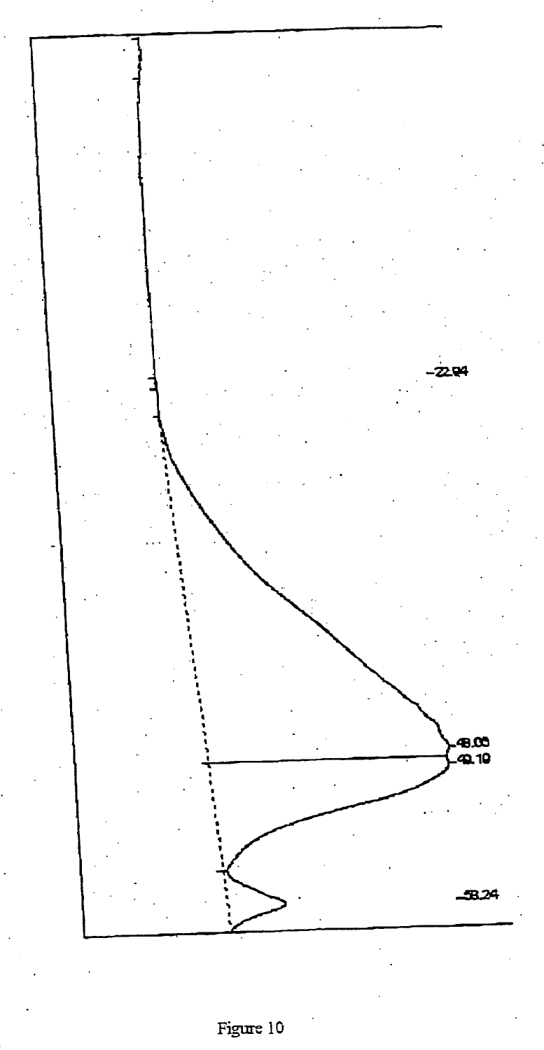

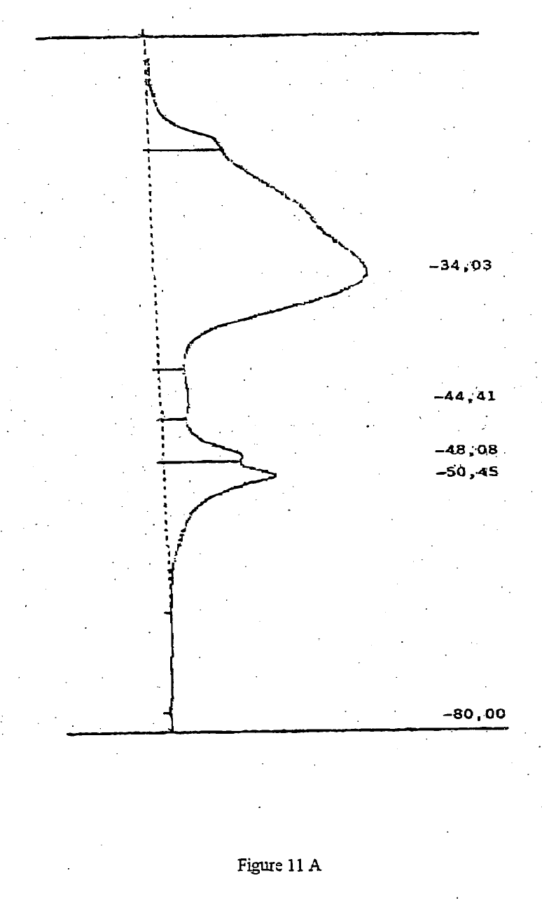

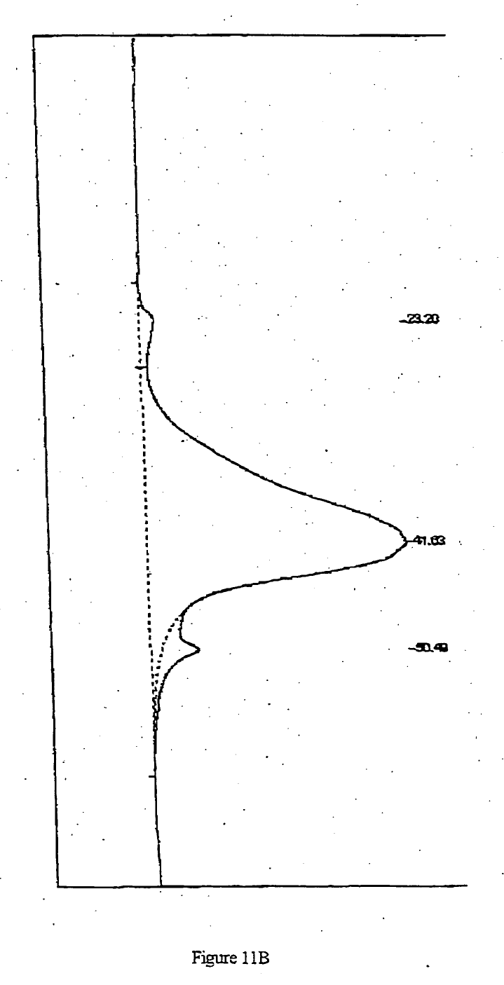

The sample obtained in example 3 having a molecular weight distribution calculated according to Harenberg and De Vries J. Chromatography 261 287-292 (1983) (FIG. 10) is fractionated by gel filtration. In particular 1 g of product is dissolved in 20 ml of 1M NaCl solution and loaded onto a column containing 1,000 ml of Sephacryl HR S-400 resin (Amersham-Pharmacia). The column is then eluted with 2,000 ml of 1M NaCl solution and collected in 50 ml fractions by fraction collector (Gilson). After the determination of product content on each fraction by carbazole reaction (Bitter and Muir Anal Biochem. 39 88-92 (1971)) the fractions containing the sample are combined in fraction A and fraction B respectively corresponding to the high molecular weight and low molecular weight fraction. These fractions are concentrated at 10% of the volume by evaporator under vacuum and are desalted on a column containing 500 ml of Sephadex G-10 resin (Amersham-Pharmacia). The solutions containing the desalted products are freeze dried obtaining fraction A and fraction B (FIG. 11A and FIG. 11B). The products obtained show the characteristics described in table 2, lines 12 and 13.

### EXAMPLE 11

The sample obtained in example 4 is degraded with nitrous acid in a controlled way as described in WO 82/03627. In particular, 5 g of sample are dissolved in 250 ml of water and cooled to 4° C. with a thermostatic bath. The pH is brought to 2 with 1N hydrochloric acid cooled at 4° C. and then 10 ml of a solution of 1% sodium nitrite are added. If necessary the pH is brought to 2 with 1N hydrochloric acid and is kept under slow stirring for 15 minutes. The solution is neutralized with 1N NaOH cooled at 4° C. Then 250 mg of sodium borohydride dissolved in 13 ml of deionized water are added and the reaction is maintained for 4 hours. The pH is brought to 5 with 1N hydrochloric acid and the reaction kept for 10 minutes to destroy the excess of sodium boro hydride, and then neutralized with 1N NaOH. The product is recovered by precipitation with 3 volumes of ethanol and then dried in a vacuum oven. The product obtained shows the characteristics described in table 2, line 14.

From the table it is evident that the product obtained by the present process shows activities comparable to the extractive heparin in the Anti-Xa test (1) while the global anticoagulant activity is reduced (2) and the tests which refer to thrombin inhibition are markedly higher (3,4). These characteristics of the product result in higher antithrombotic properties and lower side effects such as bleeding effect if compared to the extractive heparin.

TABLE 2
Anticoagulant and antithrombotic activity of the products obtained in the
described examples.

| | 1)Anti Xa | 2)aPTT | 3)HCII | 4)Anti IIa | | 6)Affinity |
|---|---|---|---|---|---|---|
| | (%) | (%) | (%) | (%) | 5)MW | ATIII(%) |
| Unfractionated Hep (4^{th} int. | 100 | 100 | 100 | 100 | 13,500 | 32% |
| STD) | | | | | | |
| LMW heparin (1^{st} Int. Std) | 84 | 30 | | 33 | 4,500 | n.d. |
| Example 1 | 76.6 | 43.4 | 256 | 118 | 15,200 | 29 |
| Example 2 | 94.3 | 57 | 294 | 208 | 13,500 | 29.5 |
| Example 3 | 112 | 88 | 346 | 223 | 14,600 | 28 |
| Example 4 | 157 | 71.5 | 362 | 600 | 22,500 a) | 29 |
| | | | | | 13,000 b) | |
| Example 5 | 150 | 70 | 352 | 213 | 24,000 a) | 31 |
| | | | | | 13,100 b) | |
| Example 6 | 150 | 79 | 335 | 333 | 23,000 a) | 33 |
| | | | | | 12,600 b) | |
| Example 7 | 120 | 92 | 346 | 247 | 13,000 a) | 29 |
| | | | | | 10,100 b) | |
| Example 8 | 153 | 75 | 332 | 240 | 22,500 a) | 34 |
| | | | | | 13,000 b) | |
| Example 9 | 157 | 71 | 346 | 233 | 23,000 a) | 35 |
| | | | | | 12,600 b) | |
| Example 10-A | 250 | 70.8 | 480 | 435 | 30,000 | 48 |
| Example 10-B | 43 | 77.7 | 145 | 27.3 | 7,600 | 24 |
| Example 11 | 97.5 | 55.5 | 230 | 210 | 5,400 | 25 |

The references from 1) to 6) have the same meaning as for Table 1.

### EXAMPLE 12

Example 12 is performed starting from 10 g of polysaccharide obtained by fermentation as described in the Italian application MI99A001465 (WO 01/02597) with a purity of 80% (FIG. 2) which are dissolved in deionized water to obtain a 1% solution. Triton X-100 is added to reach a concentration of 5% and the solution is kept at 55° C. for 2 hours under stirring. The solution is brought to 75° C. and kept at this temperature till a homogeneous turbid system is obtained and then the solution is rapidly cooled to room temperature. During the cooling two phases are formed. Said thermic treatment is repeated twice on the upper phase (organic phase). The aqueous phase containing K5 is finally 1/10 concentrated under reduced pressure and precipitated with acetone or ethanol. The organic phase is discarded.

The product obtained is K5 with 90% purity detected by proton NMR (FIG. 3) compared to the spectrum of the working standard (FIG. 1) and a retention time of 9 minutes on the HPLC analysis using two columns (Bio Rad Bio-sil SEC 250).

The process proceeds according to the following steps:

(i) The thus purified K5 is dissolved in 1,000 ml of 2 N sodium hydroxide and kept at 60° C. for 18 hours. The solution is cooled to room temperature and then brought to neutral pH with 6N hydrochloric acid. K5-N-sulfate is obtained.

The solution containing the K5-N-sulfate is kept at 40° C. and added with 10 gr sodium carbonate in one step and 20 g of adduct pyridine.SO₃ in 10 minutes. At the end of the reaction the solution is cooled to room temperature and then brought to pH 7.5-8 with a 5% hydrochloric acid solution.

The product obtained, K5-N-sulfate, is purified from salts by diafiltration using a 1,000 D cut off spirale membrane (prepscale cartridge—Millipore). The purification process is stopped when the conductivity of the permeate is less than 100 μS. The product retained by the membrane is concentrated to 10% polysaccharide using the same diafiltration system and then is freeze dried.

The ratio N-sulfate/N-acetyl in the product obtained is 9.5/0.5 measured by carbon 13 NMR (FIG. 4).

(ii) 1—Preparation of the Immobilized C5 Epimerase

To 5 mg of recombinant C5 epimerase obtained according to WO 98/48006, corresponding to 1.2×10¹¹ cpm (counts per minutes) dissolved in 200 ml of 25 mM Hepes buffer pH 7.4, containing 0.1 M KCl, 0.1% Triton X-100 and 0.015 M ethylenediaminotetracetic acid (EDTA), 100 mg of N-sulfate K5 obtained as described in step (i) are added. The solution is diafiltrated with a 30,000 D membrane at 4° C. till disappearance of K5-N-sulfate in the permeate. To the solution rententated by the membrane the buffer is changed by diafiltration against 200 mM NaHCO₃ at pH 7 and, after concentration to 50 ml, 50 ml of CNBr activated Sepharose 4B resin are added and kept to react overnight at 4° C. At the end of the reaction the amount of residual enzyme in the supernatant is measured with the Quantigold method (Diversified Biotec) after centrifugation. The enzyme in the supernatant is absent, showing that with the method described the enzyme is 100% immobilized. To occupy the sites still available the resin is washed with 100 mM tris pH 8. To measure the activity of the immobilized enzyme an amount of immobilized enzyme theoretically correspondent to 1.2×10⁷ cpm is loaded into a column. In the column obtained 1 mg of K5-N-sulfate obtained as described in step (b) dissolved in 25 mM Hepes, 0.1M KCl, 0.015 M EDTA, 0.01% Triton X-100, pH 7.4 buffer is dissolved, recirculating it through said column at 37° C. overnight at a flow rate of 0.5 ml/minute.

After purification by DEAE chromatographic system and desalting on a Sephadex G-10 the sample is freeze dried and analyzed for its content in iduronic acid by proton NMR technique as already described in WO 96/14425.

The ratio iduronic acid/glucuronic acid is 30/70 (FIG. 5).

2—Epimerization.

An amount of 10 g of the K5-N-sulfate is dissolved in 600 ml of 25 mM Hepes buffer pH 7 containing 50 mM CaCl₂. The solution obtained is recirculated through a column of 50 ml containing the resin with the immobilized enzyme.

This reaction is performed at 30° C. with a flow rate of 200 ml/hour for 24 hours. The product obtained is purified by ultrafiltration and precipitation with ethanol. The pellet is dissolved in water at 10% concentration.

An epimerized product is obtained with a ratio iduronic acid/glucuronic acid 54/46 against a ratio 0/100 of the starting material.

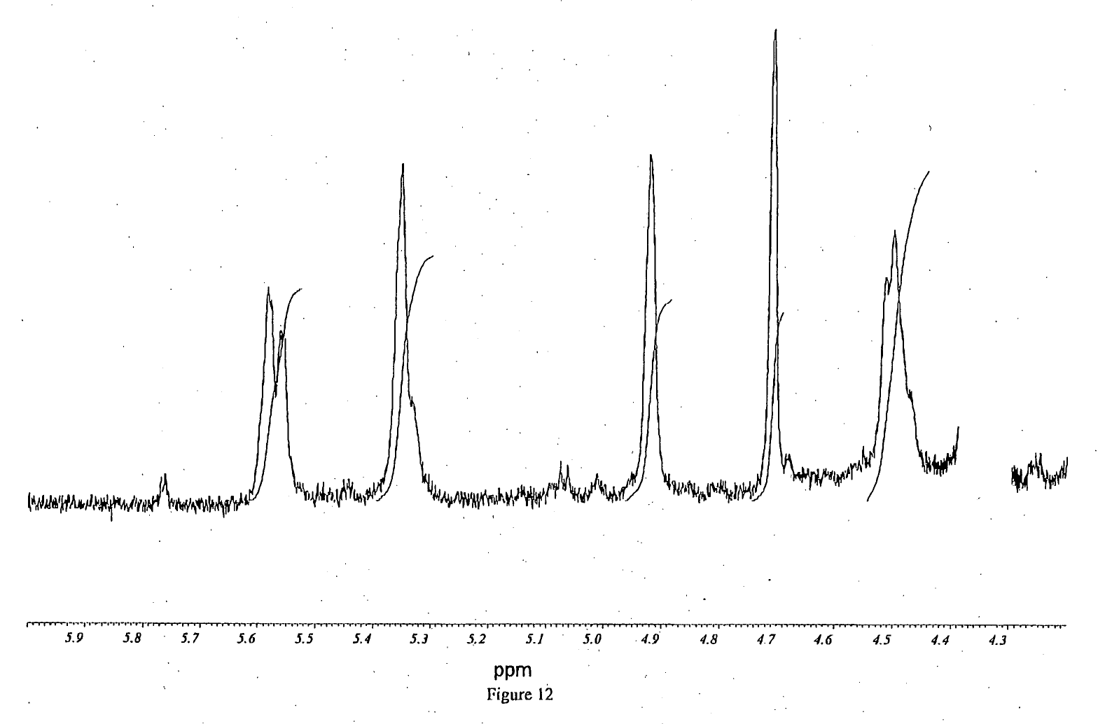

The percentage of epimerization is calculated by ¹H-NMR (FIG. 12).

The yield calculated measuring the uronic acid content against standard by the carbazole method (Bitter and Muir Anal. Biochem. 39 88-92 (1971)) is 90%.

(iii) The solution containing the epimerized product obtained in step (ii) is cooled to 10° C. with a cooling bath and then applied onto a IR 120H⁺ cationic exchange resin (50 ml). Both the column and the container of the eluted solution are kept at 10° C. After the passage of the solution the resin is washed with 3 volumes of deionized water. The pH of the flow through is more than 6. The acidic solution is brought to neutrality with a 15% aqueous solution of tetrabutylammoniun hydroxide. The solution is concentrated to 1/10 of the volume in a rotating evaporator under vacuum and freeze dried. The product is suspended in 200 ml of dimethylformamide (DMF) and added with 150 g of the adduct pyridine.SO₃ dissolved in 200 ml of DMF. The solution is kept at 45° C. for 18 hours. At the end of the reaction the solution is cooled to room temperature and added with 1,200 ml of acetone saturated with sodium chloride. The pellet obtained is separated from the solvent by filtration, dissolved with 100 ml of deionized water and sodium chloride is added to 0.2M concentration. The solution is brought to pH 7.5-8 with 2N sodium hydroxide and 300 ml of acetone are added. The pellet is separated by filtration. The solid obtained is solubilized with 100 ml deionized water and purified from the residual salts by diafiltration as described in step (i).

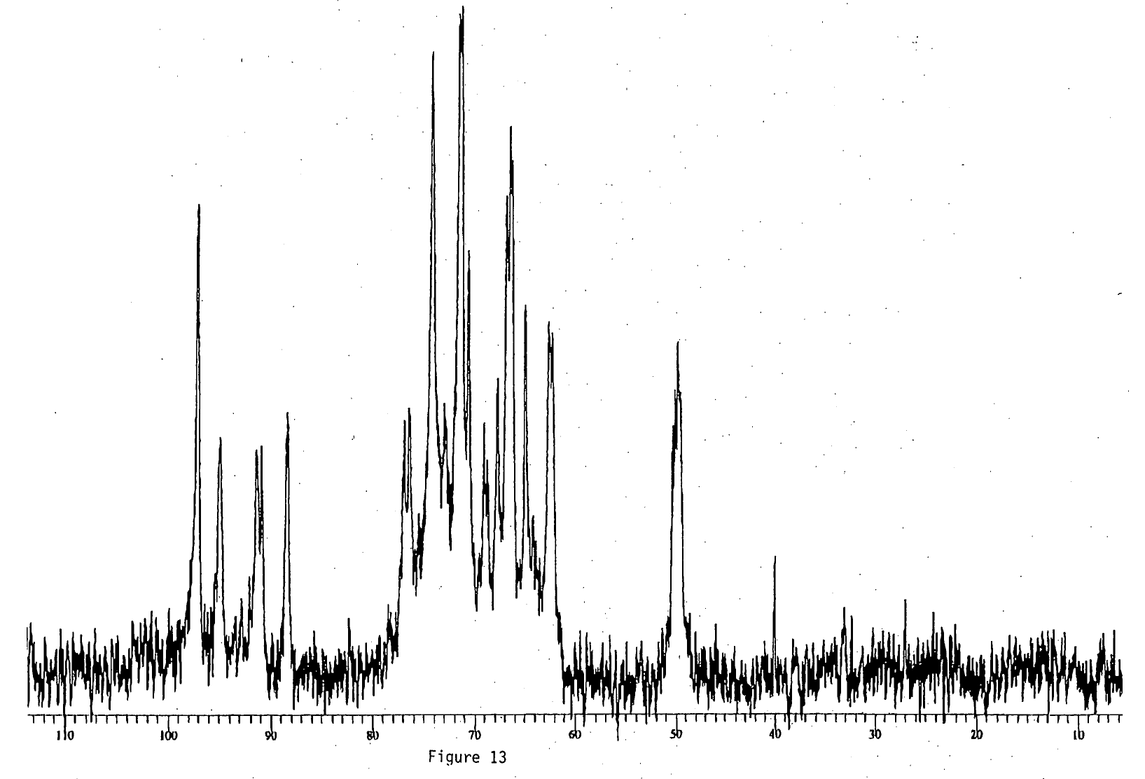

The ¹³C-NMR analysis on a dried small amount of the oversulfated product is shown in FIG. 13.

(iv) The solution containing the product of step (iii) is passed onto a IR 120H⁺ cationic exchange resin (50 ml). After the passage of the solution the resin is washed with 3 volumes of deionized water. The pH of the flow through is more than 6. The acidic solution is brought to neutrality with pyridine. The solution is concentrated to 1/10 of the volume in a rotating evaporator at 40° C. under vacuum and freeze dried. The product obtained as pyridine salt is added with 500 ml of a solution of DMSO/methanol (9/1 V/V). The solution is kept at 60° C. for 2.5 hours and then added with 50 ml deionized water and finally treated with 1,650 ml acetone saturated with sodium chloride. The solid obtained is purified by diafiltration as described in step (i) and a solution at 10% concentration is obtained.

The ¹³C-NMR analysis on a dried small amount in FIG. 14 shows a content of sulfate groups in position 6 of the amino sugar of 20%.

(v) The solution containing the product of step (iv) is passed onto a IR 120H⁺ cationic exchange resin (50 ml). After the passage of the solution the resin is washed with 3 volumes of deionized water. The pH of the flow through is more than 6. The acidic solution is brought to neutrality with an aqueous solution of 15% tetrabutylammoniun hydroxide. The solution is concentrated to 1/10 of the volume in a rotating evaporator under vacuum and freeze dried. The product as tetrabutylammonium salt is suspended in 200 ml DMF. The suspension is cooled to 0° C. and treated with 40 g of the adduct pyridine.SO₃ dissolved in 100 ml DMF. The sulfating agent is added one step. The solution is kept at 0° C. for 1.5 hours and then is treated with 750 ml acetone saturated with sodium chloride.

The solid obtained is purified by diafiltration as described in step (i).

(vi) The solution of step (v) is treated as described in step i) for N-sulfation.

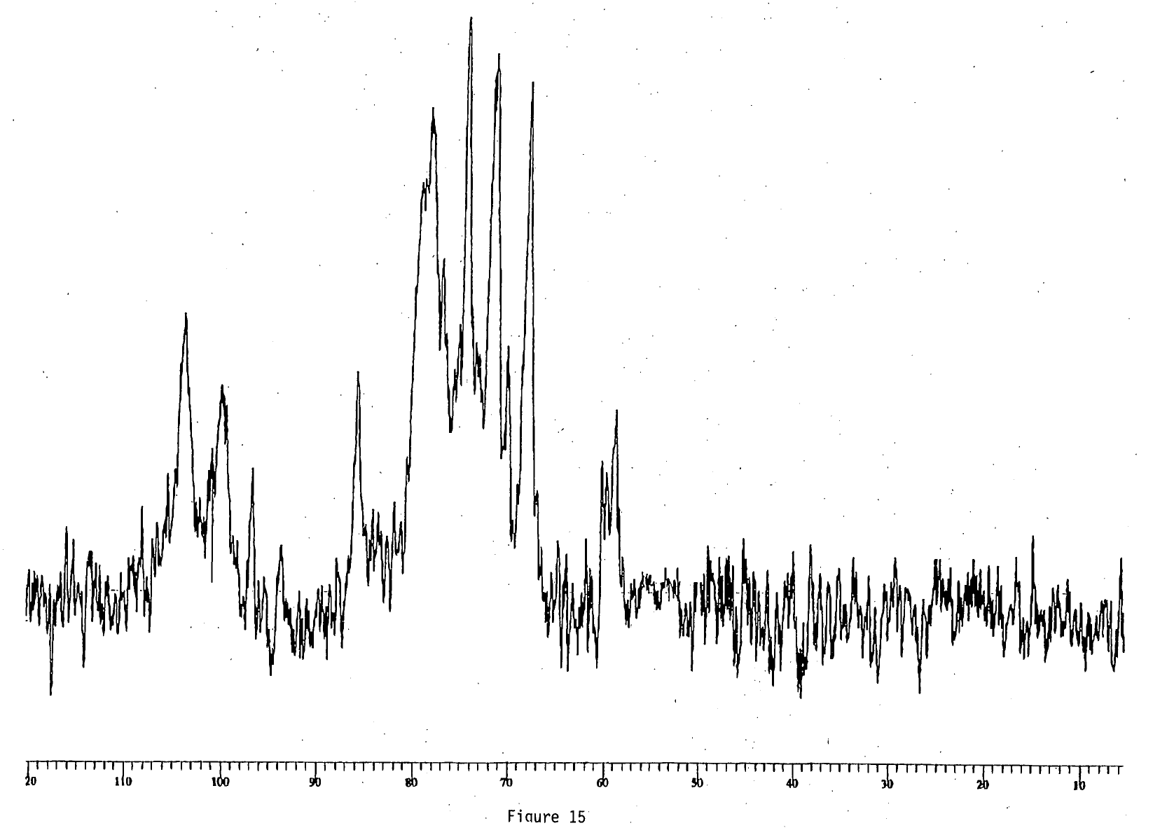

The ¹³C-NMR on a dried small amount of the product obtained is shown in FIG. 15.

The compound obtained shows a mean molecular weight of 15,700 (see reference b in tables 1 and 2), sulfate/carboxyl ratio of 2.55, iduronic acid content of 54%, N-sulfate content of >90%, 6-0 sulfate content of 85%, 3-0 sulfate glucosamine content of 20%, iduronic acid 2-O-sulfate content of 25%, glucuronic acid 3-O-sulfate content of 30%, no O-disulfated uronic units, unsulfated uronic units content of about 40%. Taking into account the sulfate/carboxyl ratio of 2.55, by difference it is calculated that about 5% of sulfate groups are present in 2-O-sulfate glucuronic acid and 3-O-sulfate iduronic acid units. Furthermore, the compound obtained contains 55% of an ATIII high affinity fraction and the following in vitro anticoagulant activities compared to those of standard heparin taken as 100: anti-Xa 157, aPTT 78, anti-IIa 373, HCII 161.

### EXAMPLE 13

The epiK5-N,O-sulfate obtained at the end of step (vi) of Example 12 is depolymerized with nitrous acid under controlled conditions as described in WO 82/03627. More particularly, 5 g of sample are dissolved in 250 ml of water and cooled to 4° C. with a thermostatic bath. The pH is brought to 2 with 1N hydrochloric acid previously cooled to 4° C., then 10 ml of a solution of 1% sodium nitrite are added thereinto and, if necessary, the pH is brought to 2 with 1N hydrochloric acid. The mixture is kept under slow stirring for 15 minutes, the solution is neutralized with 1N NaOH, previously cooled to 4° C., then 250 mg of sodium borohydride dissolved in 13 ml of deionized water are added thereinto and the slow stirring is continued for 4 hours. The pH of the mixture is brought to 5 with 1N hydrochloric acid, then said mixture is let to stand under stirring for 10 minutes to destroy the excess of sodium borohydride, and finally neutralized with 1N NaOH. The product is recovered by precipitation with 3 volumes of ethanol and drying in a vacuum oven.

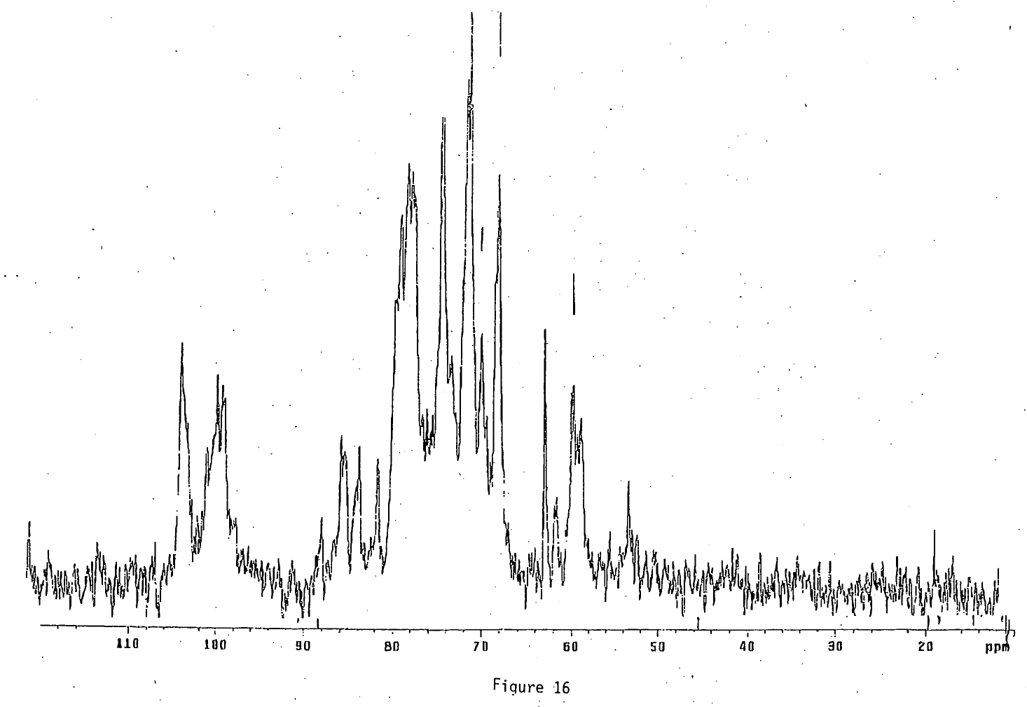

In FIG. 16, the ¹³C-NMR spectrum of the compound thus obtained is shown. The compound has a mean molecular weight of 7,400, sulfate/carboxyl ratio of 2.55, iduronic acid content of 54%, N-sulfate content>90%, 6-O-sulfate content of 85%, 3-O-sulfate glucosamine content of 20%, iduronic acid 2-O-sulfate content of 25%, glucuronic acid 3-O-sulfate content of 30%, no O-disulfated uronic units, unsulfated uronic units content of 40%. Taking into account the sulfate/carboxyl ratio of 2.55, by difference it is calculated that 5% of sulfate groups are present in 2-O-sulfate glucuronic acid and 3-O-sulfate iduronic acid units. Furthermore, the glycosaminoglycan thus obtained contains 34% of ATIII high affinity fraction and the following in vitro anticoagulant activities compared to those of heparin taken as 100: anti-Xa 99, aPTT 52, anti-IIa 203, HCII 108. In comparison with said activities of the first International Standard of low molecular weight heparin (LMWH), taken as 100, the depolymerized, C5-epimerized N,O-sulfate K5 glycosaminoglycan thus obtained shows the following anticoagulant activities: anti Xa 117, aPTT 173, anti IIa 615 (HCII was not determined for LMWH). These results show that, for the C5-epimerized N,O-sulfate K5 thus obtained, anti-IIa/aPTT and anti-IIa/anti-Xa ratios are about four times and, respectively, twice as high as those of standard heparin;
anti-IIa/aPTT and anti-IIa/anti-Xa ratios are about 3.5 times and, respectively, about five times as high as those of standard LMWH;
HCII/aPTT and HCII/anti-Xa ratios are about twice and, respectively, about as high as those of standard heparin;
   anti-Xa and HCII activities being about as high as those of standard heparin and aPTT activity being about one half that of standard heparin.

### EXAMPLES 14-16

By operating as described in example 13, starting from the products of examples 4, 5 and 7, glycosaminoglycans are obtained having respectively the characteristics shown in Table 3. Values represent a percentage against heparin (Fourth Int. Std) taken as 100. It results from this table that the glycosaminoglycan of example 13 has a biochemical activity better than that of all the other low molecular weight glycosaminoglycans.

TABLE 3

| | Anti Xa % | aPTT % | Anti IIa % | HCII % |
|---|---|---|---|---|
| Example 13 | 99 | 52 | 203 | 108 |
| Example 14 | 25 | 26 | 36 | 51 |
| Example 15 | 40 | 41 | 36 | 91 |
| Example 16 | 35 | 35 | 58 | 48 |

It is to be noted that Example 14, which was carried out starting from the product of Example 4 by operating under the same conditions as those of Example 11, was repeated several times. The activities of the products obtained were always very low and of the same order of magnitude as those given in Table 3 for Example 14.

### EXAMPLE 17

Example 12 is repeated using in step (ii) the recombinant enzyme obtained as described by Jin-Ping L. et al. (Characterization of D-glucuronosyl-C5 epimerase involved in the biosynthesis of heparin and heparan sulfate. Journal Biological Chemistry, (2001) vol. 276, 20069-20077. The compound obtained shows a mean molecular weight of 14,900 (see reference b in tables 1 and 2), sulfate/carboxyl ratio of 2.7, iduronic acid content of 54%, N-sulfate content of >90%, 6-0 sulfate content of 90%, 3-0 sulfate glucosamine content of 20%, iduronic acid 2-O-sulfate content of 30%, glucuronic acid 3-O-sulfate content of 35%, no O-disulfated uronic units, unsulfated uronic units content of about 30%. Taking into account the sulfate/carboxyl ratio of 2.7, by difference it is calculated that about 5% of sulfate groups are present in glucuronic acid 2-O-sulfate and iduronic acid 3-O-sulfate units. Furthermore, the compound obtained shows the following in vitro anticoagulant activities compared to those of standard heparin taken as 100: anti-Xa 166, aPTT 76, anti-IIa 400, HCII 283.

### EXAMPLE 18

(i) K5-N-sulfate

A solution of 8 g of 95% pure K5 in 800 ml of 2N NaOH is heated to 60° C. for 24 hours. After cooling, the solution is brought to pH 7 by 6N HCl. To the thus neutralized solution, at first 12.8 g of sodium carbonate, then, portionwise in 4 hours, 12.8 g of pyridine.SO₃ adduct in solid form are added. The reaction mixture is kept at 40° C. for 24 hours. After elimination of the salts by ultrafiltration on membrane Millipore Prepscale TFF 1000 D cut-off, the obtained product is recovered by precipitation with 3 volumes of acetone. Thus, 8 g of K5-N-sulfate are obtained. Its ¹H-NMR spectrum shows a 100% N-sulfation (absence of signals due to NH₂ and acetyl groups).

(ii) EpiK5-N-sulfate

The amount of 8 g of K5 N-sulfate thus obtained are dissolved in 200 ml of Hepes 0.25M pH 7 buffer containing 50 mM CaCl₂ and treated in solution with 9.6×10¹⁰ cpm of recombinant C5-epimerase at 30° C. for 24 hours at pH 7. At the end of the reaction, the sample is purified by elimination of the salts by ultrafiltration on Millipore Prepscale TFF 1000 D cut-off membrane and, then, precipitated with 3 volumes of acetone. Thus, 7.5 g of epiK5-N-sulfate are obtained. Its epimerization percentage, in practice the amount of iduronic units in respect of the glucuronic ones, calculated by ¹H-RMN according to the method described in WO 96/4425, is 52%.

(ii′) Depolymerized-epiK5-N-sulfate.

The amount of 7.5 g of epiK5-N-sulfate thus obtained is dissolved in 150 ml water and the solution is thermostated at 4° C., then the pH is brought to 2.2 by previously cooled 1M HCl. To the solution, 431.2 mg of sodium nitrite, corresponding to 21.56 ml of a 2% solution of sodium nitrite in water, are added. The pH is brought to 2.2 again and the reaction mixture is kept at 4° C. for 20 minutes under stirring. After neutralization to pH 7.0 with 6N HCl, 1.35 g of sodium borohydride are added to the solution. The reduction is carried out by keeping the reaction mixture at room temperature for 4 hours, then the excess of reducing agent is destroyed by bringing the pH to 5 with 1N HCl, stirring until disappearance of effervescence. The pH is brought to 7-7.2 again with 1M NaOH. The depolymerized product is recovered by ultrafiltration with Millipore TFF 1000 D cut-off membrane and subsequent precipitation with 3 volumes of acetone. Thus, 7 g of depolymerized-LMW-K5-N-sulfate are obtained. The mean molecular weight of this product, calculated via HPLC, is 6,000 D.

(iii′) LMW-epiK5-amine-O-oversulfate.

(iii′.1) Tetrabutylammonium Salt of the Depolymerized-LMW-epi K5-N-sulfate.

A solution of 7 g of depolymerized-LMW-K5-N-sulfate obtained in Step (ii′) in 350 ml water is passed through a column of IR-120H⁺. The pH of the eluate is 2.91. The percolated solution is brought to pH 7 with a 15% solution of tetrabutylammonium hydroxide (42.2 ml) and kept one hour at room temperature with controls in order to maintain the pH at a value of 7. After concentration on rotavapor of the tetrabutylammonium salt, the sample is frozen and lyophilized. Thus, 10.9 g of tetrabutylammonium salt of the depolymerized-LMW-epiK5-N-sulfate are obtained.

(iii′.2) O-oversulfation.

The tetrabutylammonium salt thus obtained is dissolved in 158 ml of dimethyl formamide, then 28.8 g of pyridine.SO₃ dissolved in 158 ml of DMF are added and the reaction mixture is kept at 45° C. for 18 hours. A volume of 316 ml of water is added to stop the reaction and the pH is brought to 7 with 30% NaOH. The depolymerized-LMW-epiK5-amine-O-oversulfate is recovered by precipitation with 3 volumes of acetone saturated with NaCl (1.896 liters) and subsequent diafiltration on Millipore TFF 1,000 D membrane until elimination of the salts.

(iv) Selective O-desulfation to Depolymerized-LMW-K5-amine-O-sulfate.

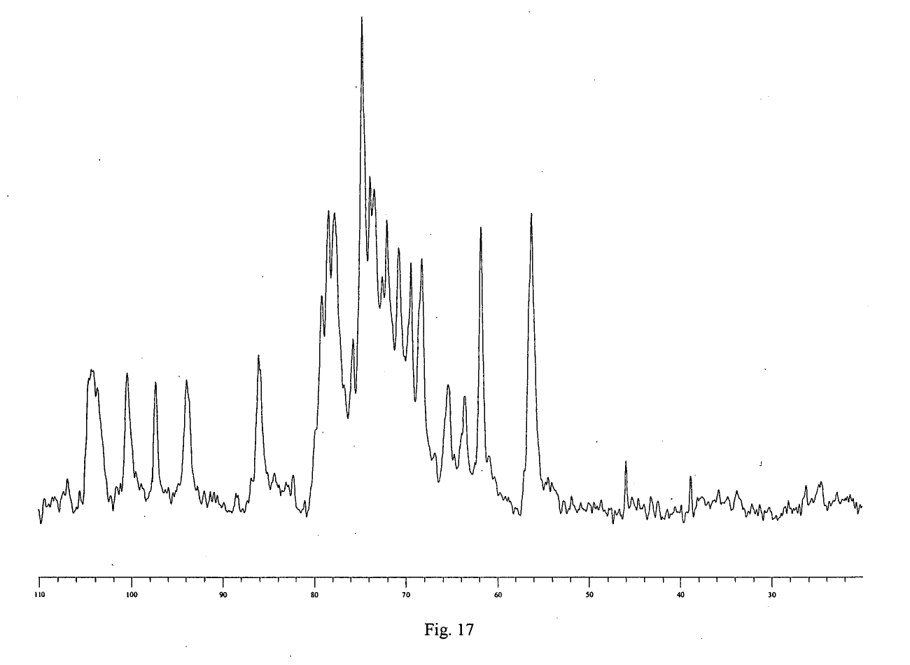

The solution containing the depolymerized-LMW-epiK5-amine-O-oversulfate obtained in (a) is passed onto a ion exchange resin IR 120H⁺ at room temperature and the pH is brought to 6.7 with pyridine. The solution is then frozen and submitted to lyophilization. The pyridine salt (10.73 g) thus obtained is dissolved in a solution containing 97 ml dimethyl sulfoxide and 11 ml methanol. The pyridine salt of the depolymerized-LMW-epiK5-amine-O-oversulfate is added when the solvent is thermostated at 65°. The reaction beginning is considered when the solvent is at 65° C. and, starting from this moment, the reaction mixture is maintained at this temperature for 2 hours and a half (in a preparation the pH at the end was 2.24). The reaction mixture is cooled by using icewater to reach about 30° C., then 4.5 ml water are added. The sample is recovered by percolating 5 volumes of acetone into the solution and the precipitate which forms is recovered by filtration on guch G4. The cake is then washed with acetone and then dissolved in water again. The pH is brought to 7.5 with 2 N NaOH. The 300 MHz ¹³C-NMR spectrum of the depolymerized-LMW-K5-amine-O-sulfate thus obtained is shown in FIG. 17.

(v) 6-O-Sulfation.

The solution is passed onto a IR 120H⁺ resin and neutralized with a 15% solution of tetrabutylammonium hydroxide. The salt thus obtained is lyophilized to give 12.34 g of a product consisting of the tetrabutylammonium salt of the above partially O-desulfated depolymerized-LMW-K5-amine-O-sulfate. The tetrabutylammonium salt thus obtained is dissolved in 150 ml DMF and 14 g of pyridine.SO₃ adduct dissolved in 75 ml DMF are added to the solution. The reaction mixture is kept at 0° C. for 90 minutes, then 110 ml water are added thereto to stop the reaction. The pH of the mixture at the end of the reaction (3.4 in a preparation) is brought to 7.2 by 2N NaOH. The sample is recovered by precipitation with 3 volumes of acetone saturated with NaCl. Some drops of water saturated with NaCl are added to favor the precipitation. A white precipitate is formed. In a preparation the operation was repeated twice to obtain 6.8 g of depolymerized-LMW-epiK5-amine-O-sulfate with a content of 80% in 6-O-sulfated glucosamine, 50% in 3-O-sulfated glucosamine, 40% in 3-O-sulfated glucuronic acid and 20% in 2-O-sulfated iduronic acid.

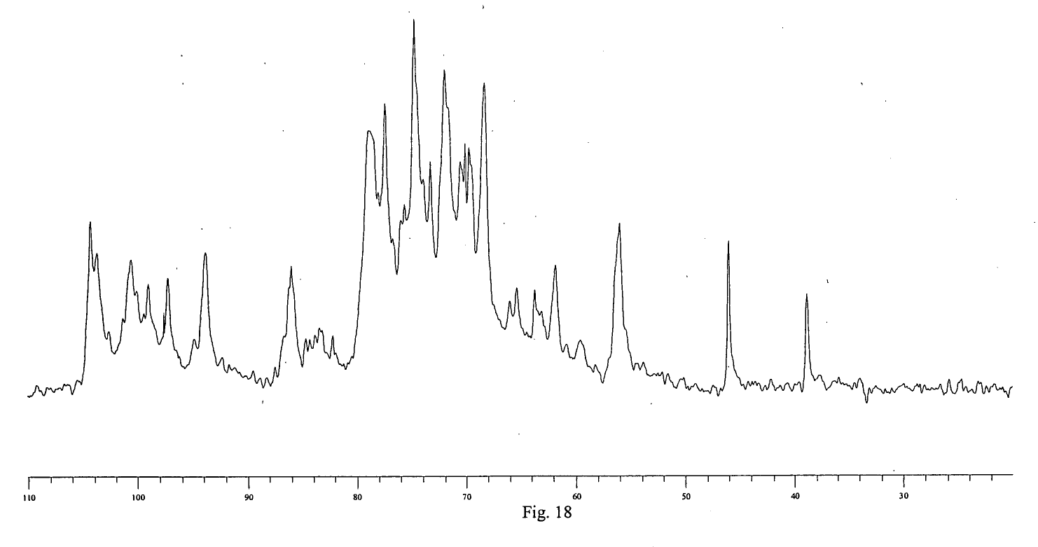

The ¹³C-NMR spectrum is shown in FIG. 18.

(vi′) N-Sulfation

The depolymerized-LMW-epiK5-amine-O-sulfate obtained at the end of step (v′) is dissolved in 500 ml water and 12.8 g of sodium carbonate dissolved in 500 ml water are then added to the solution. The pH of the solution after the addition of the carbonate is 10.51. After thermostatting the solution at 40° C., 12.8 g of solid pyridine.SO₃ are added thereinto, portionwise and in 4 hours. In a preparation the final pH of the solution was 7.2. The sample is diafiltered in the presence of NaCl and then with water. An amount of 8.0 g of depolymerized-LMW-epiK5-N,O-sulfate with a sulfation degree of 2.83 and a content of 95-100% in N-sulfated glucosamine, of 80% in 6-O-sulfated glucosamine, of 50% in 3-O-sulfated glucosamine, of 40% in 3-O-sulfated glucuronic acid and of 20% in 2-O-sulfated iduronic acid is obtained.

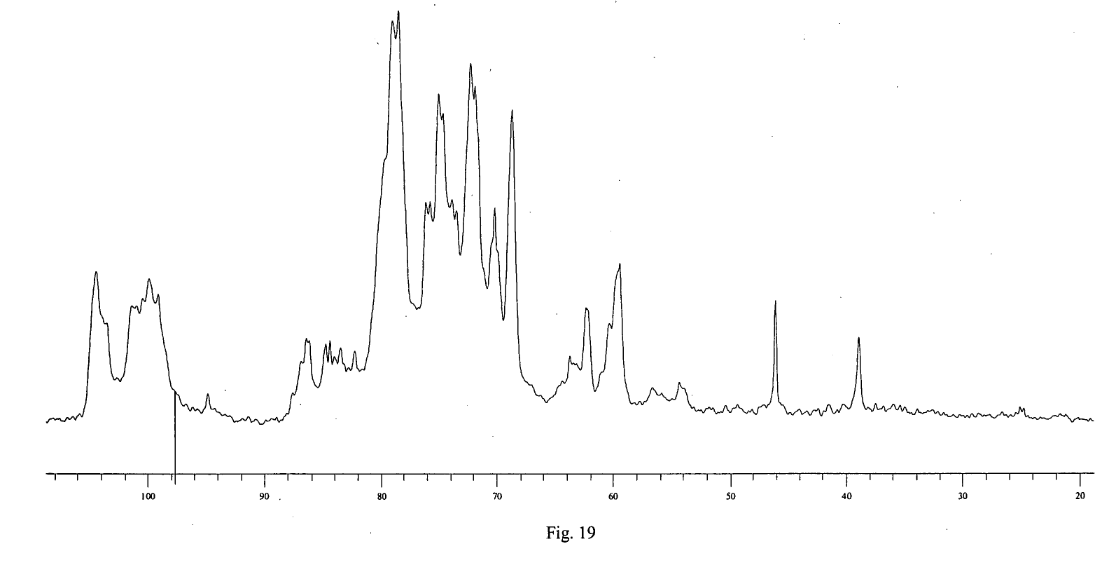

The ¹³C-NMR spectrum of the depolymerized-LMW-epiK5-N,O-sulfate thus obtained is shown in FIG. 19. In the zone between 80 and 90 ppm the signals attributable to the 2, 3 and 4 carbons, typical of the 2,5-anhydromannitol (Casu B., Nouv. Rev. Fr. Hematol., 1984 vol. 26 p.211-19) are present. The spectrum shows a shift of the signals in the zone between 80 and 90 ppm which indicates the sulfation of the carbon atom in the positions 1, 3 and 6 of said 2,5-anhydromannitol.

Without further elaboration, it is believed that one skilled in the art can, using the preceding description, utilize the present invention to its fullest extent. The preceding preferred specific embodiments are, therefore, to be constructed as merely illustrative, and not limitative of the remainder of the disclosure in any way whatsoever.

The entire disclosure of all application, patents and publications, cited above, a corresponding Italian application filed March 2000, the assignee of record being INALCO, and another corresponding Italian application (No. M12003A002498) filed on 17 Dec. 2003 in the name of the present applicants are hereby incorporated by reference.

From the foregoing description, one skilled in the art can easily ascertain the essential characteristics of this invention, and without departing from the spirit and scope thereof, can make various changes and modifications of the invention to adapt it to various usages and conditions.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding U.S. application Ser. No. 09/738,879, filed Dec. 18, 2000, and U.S. application Ser. No. 09/950,003 filed Sep. 12, 2001, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A process for the preparation of glycosaminoglycans derived from K5 polysaccharide comprising the following steps: (i) N-deacetylation/N-sulfation of the polysaccharide K5, (ii) partial C-5 epimerization of the carboxyl group of the glucuronic acid moiety to the corresponding iduronic acid moiety, (iii) oversulfation, (iv) selective O-desulfation, (v) selective 6-O-sulfation, and (vi) N-sulfation, wherein the epiK5-N-sulfate obtained at the end of step (ii) is submitted to a depolymerization step (ii′) before steps (iii)-(vi) to afford depolymerized-LMW-epiK5-N,O-sulfates.

2. The process of claim 1, wherein said depolymerization step consists of a nitrous depolymerization.

3. A process for the preparation of novel depolymerized-LMW-epiK5-N,O-sulfates having a sulfation degree of from 2.3 to 2.9, and of their pharmaceutically acceptable salts, which comprises
(i) reacting K5 with a N-deacetylating agent, then treating the N-deacetylated product with a N-sulfating agent;
(ii) submitting the K5-N-sulfate thus obtained to a C5-epimerization by glucuronosyl C5 epimerase to obtain an epiK5-N-sulfate in which the iduronic/glucuronic ratio is from 60/40 to 40/60;
(ii′) submitting the epiK5-N-sulfate having a content of 40% to 60% iduronic acid over the total uronic acids thus obtained to a nitrous depolymerization followed by a reduction with sodium borohydride to obtain a depolymerized-LMW-epiK5-N-sulfate;
(iii′) converting the depolymerized-LMW-epiK5-N-sulfate, having a content of 40% to 60% iduronic acid over the total uronic acids, into a tertiary amine or quaternary ammonium salt thereof, then treating the salt thus obtained with an O-sulfating agent in an aprotic polar solvent at a temperature of 40-60° C. for 10-20 hours;
(iv′) treating an organic base salt of the depolymerized-LMW-epiK5-amine-O-oversulfate thus obtained with a mixture dimethyl sulfoxide/methanol to perform a partial O-desulfation;
(v′) treating an organic base salt of the partially O-desulfated product thus obtained with an O-sulfating agent at a temperature of 0-5° C. to perform a 6-O-sulfation to obtain a depolymerized-LMW-epiK5-amine-O-sulfate containing at least 80% 6-O-sulfate; and
(vi′) submitting the depolymerized-LMW-epiK5-amine-O-sulfate containing at least 80% 6-O-sulfate thus obtained to a N-sulfation reaction; and isolating the depolymerized-LMW-epiK5-N-sulfate thus obtained.

4. The process of claim 3, wherein the final depolymerized-LMW-epiK5-N-sulfate is isolated in form of its sodium salt which is optionally converted into another chemically or pharmaceutically acceptable salt.

5. The process of claim 3, wherein the depolymerized-LMW-epiK5-N-sulfate obtained at the end of step (ii′) has a mean molecular weight of from about 1,500 to about 12,000.

6. The process of claim 5, wherein said mean molecular weight is from about 1,500 to about 7,500.

7. The process of claim 3, wherein said depolymerized-LMW-epiK5-N-sulfate obtained at the end of step (ii′) consists of a mixture of chains in which at least 90% of said chains has the formula II 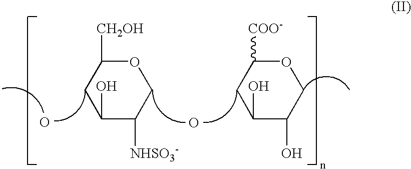
in which 40%-60% of the uronic units are those of iduronic acid, n is a integer from 2 to 20 and in which a 2,5-anhydromannitol unit of structure (a) 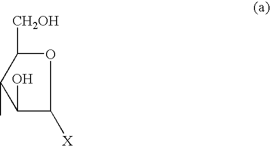
in which X represents a hydroxymethyl group, is present at the reducing end of the majority of the chains in said mixture of chains; and the corresponding cation is chemically or pharmaceutically acceptable.

8. Process according to claim 7, wherein said depolymerized-LMW-epiK5-N-sulfate consists of a mixture of chains in which the preponderant species has the formula II′a 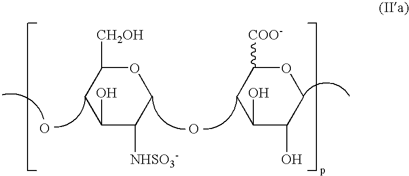
wherein 40% to 60% of the uronic units are those of iduronic acid and p is an integer from 4 to 8 and in which a 2,5-anhydromannitol unit of structure (a) 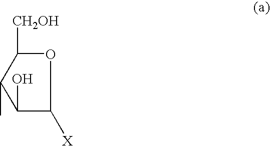
in which X represents a hydroxymethyl group, is present at the reducing end of the majority of the chains in said mixture of chains.

9. Process according to claim 8, wherein said depolymerized-LMW-epiK5-N-sulfate consists of a mixture of chains in which the preponderant species has the formula II′b 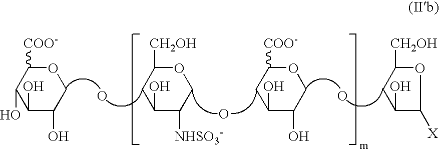
in which X hydroxymethyl, m is 4, 5 or 6, the corresponding cation is a chemically or pharmaceutically acceptable ion and the glucuronic and iduronic units are present alternately, the non reducing end being a glucuronic or iduronic unit, with a ratio glucuronic/iduronic from 45/55 to 55/45.

10. The process of claim 3, wherein, in step (iv′), a solution dimethysulfoxide/methanol about 9/1 (V/V) is used and the obtained solution is maintained at 45-90° C. for a period of time of from 1 to 8 hours.

11. A depolymerized-LMW-epiK5-N,O-sulfate obtainable according to claim 1.

12. A depolymerized-LMW-epiK5-N,O-sulfate obtainable according to claim 3.

13. The depolymerized-LMW-epiK5-N,O-sulfate of claim 12 having a sulfation degree of from 2.3 to 2.9, a mean molecular weight of from about 1,500 to about 12,000 and, at the reducing end of the majority of its chains, the structure (a′) 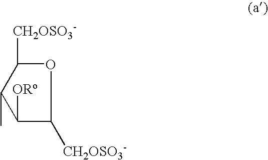
in which R° represents hydrogen or SO₃⁻, or a pharmaceutically acceptable salt thereof.

14. The depolymerized-LMW-epiK5-N,O-sulfate of claim 13, having a mean molecular weight of from about 1,500 to about 8,000 and a sulfation degree from 2.5 to 2.9.

15. The depolymerized-LMW-epiK5-N,O-sulfate of claim 14, having a sulfation degree of from 2.7 to 2.9.

16. The depolymerized-LMW-epiK5-N,O-sulfate of claim 15, having a mean molecular weight of about 6,000.

17. The depolymerized-LMW-epiK5-N,O-sulfate of claim 14, wherein said mean molecular weight is of from about 1,500 to about 5,000

18. The depolymerized-LMW-epiK5-N,O-sulfate of claim 17, wherein said mean molecular weight is from about 1,500 to about 4,000.

19. The depolymerized-LMW-epiK5-N,O-sulfate of claim 13, having a mean molecular weight of about 6,000, a sulfation degree of from 2.7 to 2.9, a content of 80%-95% in glucosamine 6-O-sulfate, of 95%-100% in glucosamine N-sulfate, of 45%-55% in glucosamine 3-O-sulfate, of 35%-45% in glucuronic acid 3-O-sulfate, of 15%-25% in iduronic acid 2-O-sulfate, or a pharmaceutically acceptable salt thereof.

20. The depolymerized-LMW-epiK5-N,O-sulfate of claim 13 consisting of a mixture of chains in which at least 80% of said chains has the formula IV 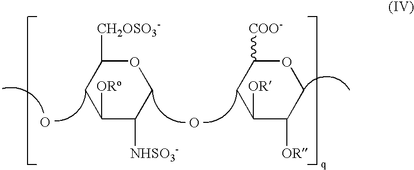
wherein the 40%-60% of the uronic units are those of iduronic acid, q is an integer from 2 to 17, R°, R′ and R″ are hydrogen or SO₃⁻ for a sulfation degree of from 2.3 to 2.9;
and the corresponding cation is chemically or pharmaceutically acceptable.

21. The depolymerized-LMW-epiK5-N,O-sulfate of claim 20, consisting of a mixture of chains in which at least 80% of said chains has the formula IV wherein q is an integer from 2 to 14.

22. The depolymerized-LMW-epiK5-N,O-sulfate of claim 20, consisting of a mixture of chains in which at least 80% of said chains has the formula IV wherein q is an integer from 2 to 11.

23. The depolymerized-LMW-epiK5-N,O-sulfate of claim 20, consisting of a mixture of chains in which the preponderant species is a compound of formula 1V wherein q is 8 or 9, R° is 45%-55% SO₃⁻, R′ is 35%-45% SO₃⁻ in glucuronic acid, R″ is 15%-25% SO₃⁻ in iduronic acid, for a sulfation degree of from 2.7 to 2.9.

24. A pharmaceutical composition comprising, as an active ingredient, a pharmacologically active amount of a depolymerized-LMW-epiK5-N,O-sulfate having a sulfation degree of from 2.3 to 2.9, a mean molecular weight of from about 1,500 to about 12,000 and, at the reducing end of the majority of its chains, the structure (a′) 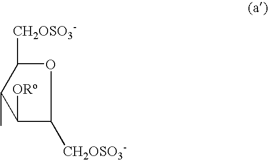
in which R° represents hydrogen or SO₃⁻, or of a pharmaceutically acceptable salt thereof, in admixture with a pharmaceutical carrier.

25. The composition of claim 24, wherein said active ingredient is a depolymerized-LMW-epiK5-N,O-sulfate having a mean molecular weight of about 6,000, a sulfation degree of from 2.7 to 2.9, a content of 80%-95% in glucosamine 6-O-sulfate, of 95%-100% in glucosamine N-sulfate, of 45%-55% in glucosamine 3-O-sulfate, of 35%-45% in glucuronic acid 3-O-sulfate, of 15%-25% in iduronic acid 2-O-sulfate, or a pharmaceutically acceptable salt thereof.

26. A method for the control of the coagulation in a mammal, which comprises administering to said mammal in need of said control of the coagulation an effective amount of a depolymerized-LMW-epiK5-N,O-sulfate having a sulfation degree of from 2.3 to 2.9, a mean molecular weight of from about 1,500 to about 12,000 and, at the reducing end of the majority of its chains, the structure (a′) 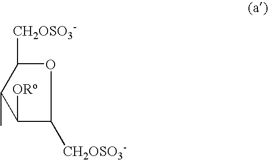
in which R° represents hydrogen or SO₃⁻, or a pharmaceutically acceptable salt thereof.

27. The method of claim 26, wherein said depolymerized-LMW-epiK5-N,O-sulfate has a mean molecular weight of about 6,000, a sulfation degree of from 2.7 to 2.9, a content of 80%-95% in glucosamine 6-O-sulfate, of 95%-100% in glucosamine N-sulfate, of 45%-55% in glucosamine 3-O-sulfate, of 35%-45% in glucuronic acid 3-O-sulfate, of 15%-25% in iduronic acid 2-O-sulfate.

28. A method for preventing or treating thrombosis in a mammal, which comprises administering to said mammal an effective amount of a depolymerized-LMW-epiK5-N,O-sulfate having a sulfation degree of from 2.3 to 2.9, a mean molecular weight of from about 1,500 to about 12,000 and, at the reducing end of the majority of its chains, the structure (a′) 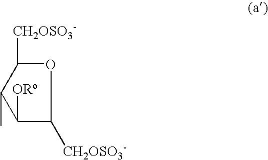
in which R° represents hydrogen or SO₃⁻, or a pharmaceutically acceptable salt thereof.

29. The method of claim 28, wherein said depolymerized-LMW-epiK5-N,O-sulfate has a mean molecular weight of about 6,000, a sulfation degree of from 2.7 to 2.9, a content of 80%-95% in glucosamine 6-O-sulfate, of 95%-100% in glucosamine N-sulfate, of 45%-55% in glucosamine 3-O-sulfate, of 35%-45% in glucuronic acid 3-O-sulfate, of 15%-25% in iduronic acid 2-O-sulfate or of a pharmaceutically acceptable salt thereof.

30. The method of claim 26, wherein said effective amount is administered in a pharmaceutical composition comprising from 5 to 100 mg of said depolymerized-LMW-epiK5-N,O-sulfate or of a pharmaceutically acceptable salt thereof, in admixture with a pharmaceutical carrier.

31. The method of claim 28, wherein said effective amount is administered in a pharmaceutical composition comprising from 5 to 100 mg of said depolymerized-LMW-epiK5-N,O-sulfate or of a pharmaceutically acceptable salt thereof, in admixture with a pharmaceutical carrier.
